(19) United States
(12) Patent Application Publication
(10) Pub. No.: US 2002/0156787 A1
(43) Pub. Date: Oct. 24, 2002

(54) Method and system for internet based event planning and event management

(76) Inventors: Daniel E. Jameson, Culver City, CA (US); Eileen H. Newmark, Los Angeles, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/075,474

(22) Filed: Feb. 13, 2002

Related U.S. Application Data
(60) Provisional application No. 60/268,628, filed on Feb. 13, 2001.
(60) Provisional application No. 60/269,212, filed on Feb. 15, 2001.

(51) Int. Cl. G06F 7/00

(52) U.S. Cl. 707/10

(57) ABSTRACT

An Internet-based system and method for planning and managing an event. A plurality of modules provide tools to plan and manage an event. An event planning system provides a method for planning and managing all aspects of an event. An event info center provides a URL for an event where attendees of the event may access information for the event at once central location. A task manger allows users and event planners to create and assign a plurality of tasks to event attendees. The created tasks may be assigned to various users, modified, and deleted dynamically. Any changes made to event information by the planner may be dynamically updated on the event Web site. An expense tracker provides an improved method for managing event related expenses. A personalized management module allows users to maintain a personalize event home page where users may view their tasks, agenda, and event information.

### CROSS-REFERENCE TO RELATED APPLICATIONS

This application claims the benefit of U.S. provisional applications 60/268,628, filed Feb. 13, 2001, and 60/269,212, filed Feb. 15, 2001, the contents of both provisional applications are incorporated herein by reference.

### BACKGROUND OF THE INVENTION

The present invention relates generally to networked computer systems and in particular to a computer system for operating a Web-based event planning and management system.

The development of the Internet has improved the capacity for large numbers of people in separate locations to access shared information. Software and Web site developers have used this accessibility to simplify transactions, such as shopping, banking, and investing, where the Internet has permitted people to engage in these transactions in a new way. Among these developers, some have created Internet-based methods of sending party invitations, or invitations to other events, as an alternative to the traditional postal or telephone methods of initiating parties and other events. Using the Internet, a planner of an event could create a web page with information about the event, such as date, time, and location, and send the address of the Web site to those people they wished to invite. Additionally, the planner could make available maps, directions, lists of the other guests invited, pictures and graphics, itineraries, and any other information suitable for the event. The address of a Web site is a Uniform Resource Locator (“URL”) consisting of only one line of characters and numbers that could be sent easily through electronic mail (“e-mail”) or over the telephone. The advantage of such a system is that a large amount of information, identical for every guest, can be made available to a large group of people with little cost and effort. Alternative means, such as placing phone calls or mailing material through a postal service, would require a great amount of labor and economic expense.

These Web sites have limited functionality associated with them. At most, guests would only be able to respond or RSVP indicating whether they would be attending, leave messages to be readable on the Web site, or indicate whether they would be bringing a food, beverage, or other item to the event. These Web sites have little utility for planning complex events where there are a large number of tasks and responsibilities that must be completed for the event to take place. Additionally, an efficient method for providing attendees with extensive information about the event or managing a large number of tasks and attendees does not exist. Currently, lists of items are presented in a large, serial list. If interested in a particular subject or person, the attendee must scroll down the long list on the screen and scan for the item of interest. Furthermore, a dynamic environment does not presently exist where Web pages can be personalized for each attendee.

Accordingly, there is a need for an event planning and management system that allows for efficient management of a complex event and allows for greater interaction among planners and attendees using the system, including the ability to quickly and easily disseminate detailed event information, modify the information, and have the information update automatically on the event Web site.

### SUMMARY OF THE INVENTION

The present invention addresses and alleviates the above mentioned deficiencies associated with the prior art. More particularly, the present invention provides an event planning solution for use in connection with the Internet. An event planning solution is a management system that includes several modules or engines that may operate in conjunction with each other to provide for the planning and management of an event.

In one embodiment, the present invention provides a computerized method for managing event information using a data communications network comprising the steps of providing an event management server operably coupled to the data communications network, providing a database operably coupled to the event management server having event specific information stored thereon, receiving by the event management server from a planner client a modification of the event specific information via the data communications network, dynamically updating by the event management server the event specific information stored on the database using the modification of the event specific information, receiving by the event management server from a user client an event information request via the data communications network, generating by the event management server the dynamically updated event specific information, and transmitting by the event management server to the user client the dynamically updated event specific information via the data communications network. Generating the dynamically update event specific information may include generating event data using an event information center module, a task management module, an expense tracking module, or any other event management module.

In another embodiment, the present invention provides a computerized method for managing event information using a data communications network comprising the steps of providing an event management server operably coupled to the data communications network, providing a database operably coupled to the event management server having event specific information stored thereon, generating an event site displaying the event specific information, receiving a modification request from a user client requesting modification to the event specific information, the modification request using a data processing module, dynamically updating the event specific information, generating the dynamically updated event specific information, and transmitting the dynamically updated event specific information to the event site, wherein the dynamically updated event specific information is displayed. The data processing module may be an event information center module, a task management module, an expense tracking module, or any desired event management module. The method may further include the steps of receiving a user identification from one of the plurality of users, and transmitting a user-specific event page to the one of the plurality of users, the user-specific event page including the event specific information and the user-specific information.

In another embodiment, the present invention provides a computerized method for managing event information using a data communications network comprising the steps of transmitting a user identification to an event management server operably coupled to the data communications network, receiving a user-specific web page display, the web page display including event data, the event data stored on an event management database coupled to the event management server, and transmitting a request to the event management server over the data communications network, transmitting the request using a data processing module, the data processing module configured to modify event data in response to the request. The data processing module may be an event information center module, a task management module, an expense tracking module, or any desired event management module.

In another embodiment, the present invention provides for a computerized event planning system comprising an event management server operable coupled to a data communications network, an event management database operably coupled to the event management server, the event management database having event data, a data processing module operably coupled to the event management server, characterized in that the data processing module receives a user request transmitted over the data communications network from a system user, further characterized in that the data processing module modifies the event data in response to the user request, and transmits the modified event data to the system user over the data communications network, The data processing module may be an event information center module, a task management module, an expense tracking module, or any desired event management module.

In the above embodiments, the user may be any person who accesses the event planning and management system. The user may include, but is not limited to, a planner, a system administrator, an attendee, or a guest.

### BRIEF DESCRIPTION OF THE DRAWINGS

These and other features, aspects, and advantages of the present invention will become better understood by referring to the following description and accompanying drawings where:

FIG. 1 is an object diagram of Web browsers and a Web server in an exemplary Internet-based event management system built in accordance with an embodiment of the present invention;

FIG. 2 is a hardware architecture diagram for an exemplary general purpose computer capable of hosting an exemplary event management system in accordance with an embodiment of the present invention;

FIG. 3 is a detailed object diagram of an embodiment of the event management system server in accordance with an embodiment of the present invention;

FIG. 4 is a process flow diagram of the steps an event planner takes to create an event using the administration center in accordance with an embodiment of the present invention;

FIG. 5 is an exemplary Web page showing an administration center planner main page in accordance with an embodiment of the present invention;

FIG. 6 is an exemplary Web page showing an administration center event set up page in accordance with an embodiment of the present invention;

FIG. 7 is an exemplary Web page showing an administration center event home-page layout creation page in accordance with an embodiment of the present invention;

FIG. 8 is an exemplary Web page showing an administration center master planner page in accordance with an embodiment of the present invention;

FIG. 9 is an exemplary Web page showing an administration center registration form configuration page in accordance with an embodiment of the present invention;

FIG. 10 is a process flow diagram of the steps a user takes to use the event info center in accordance with an embodiment of the present invention;

FIG. 11 is an exemplary Web page showing an event info center general information page in accordance with an embodiment of the present invention;

FIG. 12 is an exemplary Web page showing an event info center schedule information page in accordance with an embodiment of the present invention;

FIG. 13 is an exemplary Web page showing an event info center hotel information page in accordance with an embodiment of the present invention;

FIG. 14 is an exemplary Web page showing an event info center speaker information page in accordance with an embodiment of the present invention;

FIG. 15 is an exemplary Web page showing a event registration page in accordance with an embodiment of the present invention;

FIG. 16 is an exemplary Web page showing an event registration event selection page in accordance with an embodiment of the present invention;

FIG. 17 is an exemplary Web page showing an event registration activity selection page in accordance with an embodiment of the present invention;

FIG. 18 is an exemplary Web page showing a conference fee selection page in accordance with an embodiment of the present invention;

FIG. 19 is an exemplary Web page showing an event registration attendee information page in accordance with an embodiment of the present invention;

FIG. 20 is an exemplary Web page showing an event registration survey page in accordance with an embodiment of the present invention;

FIG. 21 is an exemplary Web page showing an event registration payment selection page in accordance with an embodiment of the present invention;

FIG. 22 is an exemplary Web page showing an event registration confirmation page in accordance with an embodiment of the present invention;

FIG. 23 is a process flow diagram of the steps an user takes to access the event management tools;

FIG. 24 is an exemplary Web page showing an event user welcome page in accordance with an embodiment of the present invention;

FIG. 25 is an exemplary Web page showing a user's personalized event home page in accordance with an embodiment of the present invention;

FIG. 26 is an exemplary Web page showing a RSVP page in accordance with an embodiment of the present invention;

FIG. 27 is an exemplary Web page showing a user profile page in accordance with an embodiment of the present invention;

FIG. 28 is an exemplary Web page showing a user agenda page in accordance with an embodiment of the present invention;

FIG. 29 is an exemplary Web page showing a user agenda page for a specific session in accordance with an embodiment of the present invention;

FIG. 30 is an exemplary Web page showing a message manager view message page in accordance with an embodiment of the present invention;

FIG. 31 is an exemplary Web page showing a message manager post message page in accordance with an embodiment of the present invention;

FIG. 32 is an exemplary Web page showing a message manager user search page in accordance with an embodiment of the present invention;

FIG. 33 is an exemplary Web page showing a task manager task list page in accordance with an embodiment of the present invention;

FIG. 34 is an exemplary Web page showing a task manager monthly calendar view page in accordance with an embodiment of the present invention;

FIG. 35 is an exemplary Web page showing a task manager task detail page in accordance with an embodiment of the present invention;

FIG. 36 is an exemplary Web page showing a task manager category creation page in accordance with an embodiment of the present invention;

FIG. 37 is an exemplary Web page showing a task manager task creation page in accordance with an embodiment of the present invention;

FIG. 38 is an exemplary Web page showing a task generation tool in accordance with an embodiment of the present invention;

FIG. 39 is an exemplary Web page showing a housing manager page in accordance with an embodiment of the present invention;

FIG. 40 is an exemplary Web page showing an expense tracker main page in accordance with an embodiment of the present invention;

FIG. 41 is an exemplary Web page showing an expense tracker category creation page in accordance with an embodiment of the present invention;

FIG. 42 is an exemplary Web page showing an expense tracker expense entry page in accordance with an embodiment of the present invention;

FIG. 43 is an exemplary Web page showing an expense tracker report creation page in accordance with an embodiment of the present invention;

FIG. 44 is an exemplary Web page showing an expense tracker custom report creation page in accordance with an embodiment of the present invention;

FIG. 45 is an exemplary Web page showing an expense tracker report page format selection page in accordance with an embodiment of the present invention;

FIG. 46 is an exemplary Web page showing an expense tracker category selection page in accordance with an embodiment of the present invention;

FIG. 47 is an exemplary Web page showing a photo center photo album page in accordance with an embodiment of the present invention;

FIG. 48 is an exemplary Web page showing a photo center planner's photos page in accordance with an embodiment of the present invention; and

### DETAILED DESCRIPTION

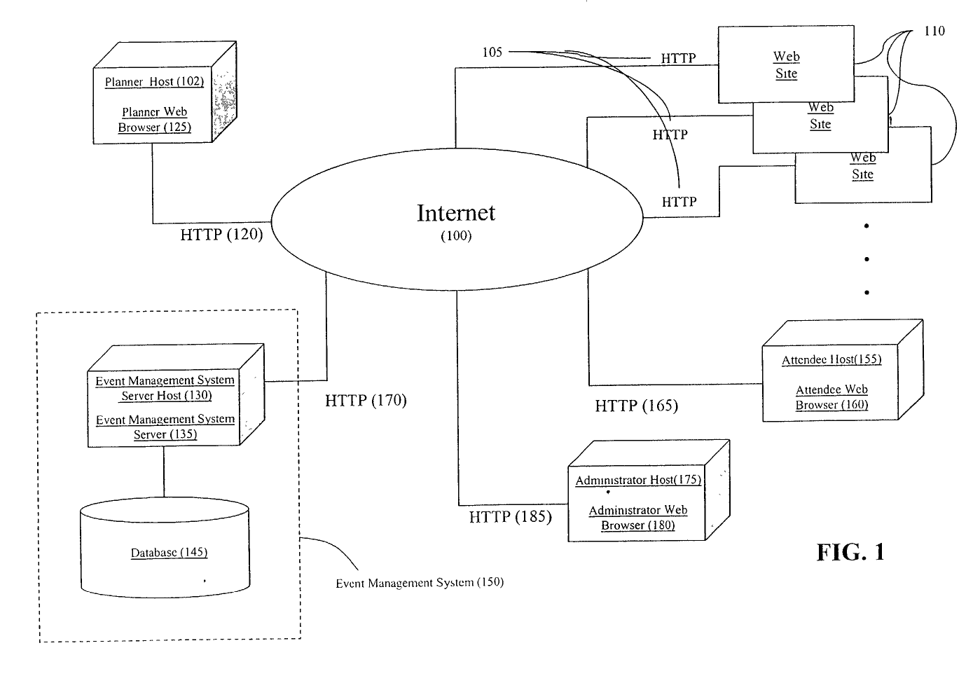

FIG. 1 is an object diagram of a Web server and Web browsers coupled via a data communications network to an exemplary event management system built according to the present invention. An event management system server host 130 is provided which hosts an event management system server 135. The event management system server 135 communicates to other objects on the Internet 100 using an event management system server communications link 170. The event management system server communications link 170, and other communication links, may be implemented using the Hyper Text Transfer Protocol (HTTP) on top of the Transmission Control Protocol/Internet Protocol (TCP/IP) suite of communications protocols. The Internet connection may include conventional telephone lines, ISDN lines, ADSL lines, DSL lines, cable connection, satellite connection, and the like. Any other suitable communication links may be used. The event management system server 135 transmits and receives information to and from the planner Web browser 125, the attendee Web browser 160, and the administrator Web browser 180. Information is transmitted and received using a plurality of Web pages as described below. The event management system server 135 may create documents and Web pages by retrieving information stored in at least one event management system database 145 coupled to the event management system server 135. Information regarding an event is stored as data on the at least one database 145. The database 145 stores information and data that is used in the operation of the event management system. Data may be retrieved from and stored onto the database 145 by the event management system server 135. The combination of the event management system server 135 and the database 145 comprise the event management system 150.

Planner host 102 hosts a planner Web browser 125, or planner client, using such generic Web browsers as Internet Explorer or Netscape Navigator, which communicates to other objects on the Internet using an HTTP based planner Web browser communication link 120. The planner Web browser 125 is used by an event planner to communicate with the event management system server 135 in order to access the event management system, create an event, plan the event, manage the event, and use a plurality of event management tools.

An attendee host 155 hosts a Web browser 160, or attendee client, which is coupled to the Internet 100 over a Web browser communications link 165. The attendee uses the Web browser 125 to access the event management system and use the plurality of event management tools.

An system administrator host 175 hosts a Web browser 180, or administrator client, which is coupled to the Internet 100 over a Web browser communications link 185. The administrator uses the Web browser 185 to access the event management system and use the plurality of event management tools. The administrator and the planner may have authorization to access tools and operations unavailable to event attendees.

A plurality of Web sites 110 may also be coupled to the Internet via a plurality of HTTP based Web site communications links 105. The Web sites supply HTML documents at the request of the Web browser to view other Web sites while using the event management system.

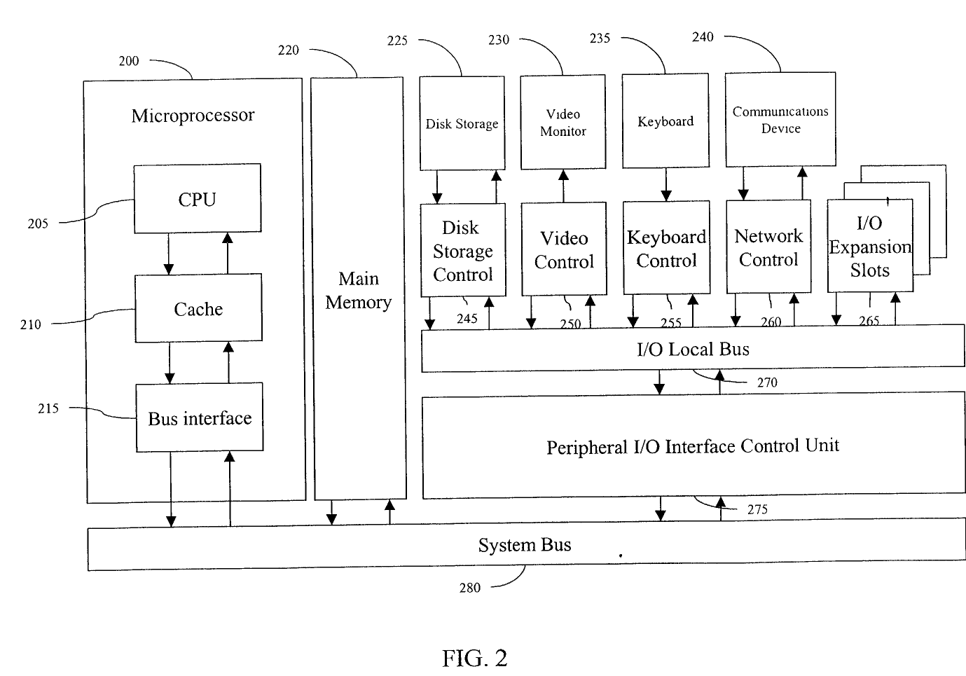

FIG. 2 is a diagram of an exemplary architecture for a general purpose computer capable of serving as a host for the event management system 150. A microprocessor 200, comprised of a Central Processing Unit (CPU) 205, memory cache 210, and bus interface 215, is coupled via system bus 280 to main memory 220 and I/O control unit 275. The I/O interface control unit is coupled via I/O local bus 270 to disk storage controller 245, video controller 250, keyboard controller 255, network controller 260, and Input Output (I/O) expansion slots 265. The disk storage controller 245 is coupled to disk storage device 225. The video controller 250 is coupled to video monitor 230. The keyboard controller 255 is coupled to keyboard 235. The network controller 260 is coupled to a communications device 240.

Computer program instructions implementing the event management system 150 software components are stored on the disk storage device 225 until the microprocessor 200 retrieves the computer program instructions and stores them in the main memory 220. The microprocessor 200 then executes the computer program instructions stored in the main memory 220 to implement the event management system software components. The disk storage device 225 is used to as permanent data storage for the database 145. The event management system server host 130 is coupled to Internet 100 via the communications device 240.

Users of the event management system may operate a Web browser on a personal computer or work station equipped with a keyboard, mouse, display monitor, and modem or ethernet transceiver to transmit and receive information over the Internet. The term “user” is used to describe, generally, any person accessing the event management system. For example, the user may include, but is not limited to, the event planner, the event attendee, the system administrator, a guest of an attendee, or any other user of the event management system. Different users may have different levels of access to the event management system. For example, the planner of the event preferably sets up the event, creates the task list, and assigns tasks to guests of the event. Accordingly, the event management system may be configured to control access to the different functions and tools.

The user may enter the information to be transmitted into the personal computer using the keyboard and a mouse. The entered data may be transmitted and received by the modem or ethernet transceiver over the Internet using an Internet connection. Information received from the Internet may be displayed on the display monitor. Alternatively, the user may use a television equipped with a set top box (“STB”) with Internet capabilities equipped with a control unit to transmit and receive information via the Internet connection. An exemplary STB with Internet capabilities is sold under the trademark WebTV by Microsoft.

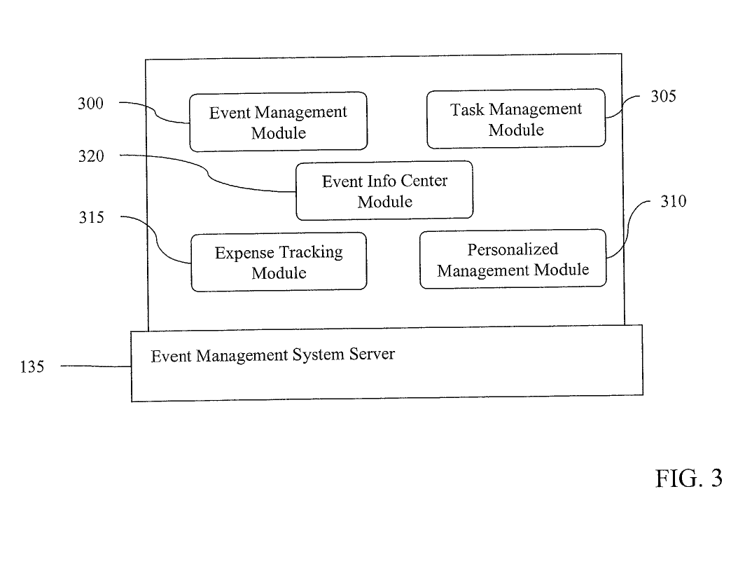

FIG. 3 is a detailed object diagram of an embodiment of the event management system server in accordance with an embodiment of the present invention. Among other modules located on the server are an event management module 300, a task management module 305, a personalized management module 310, and an expense tracking module 315, and an event info center module 320. These modules are preferably software but may also be performed by hardware, firmware and/or software. The server and interrelated modules may perform independent functions sharing common data.

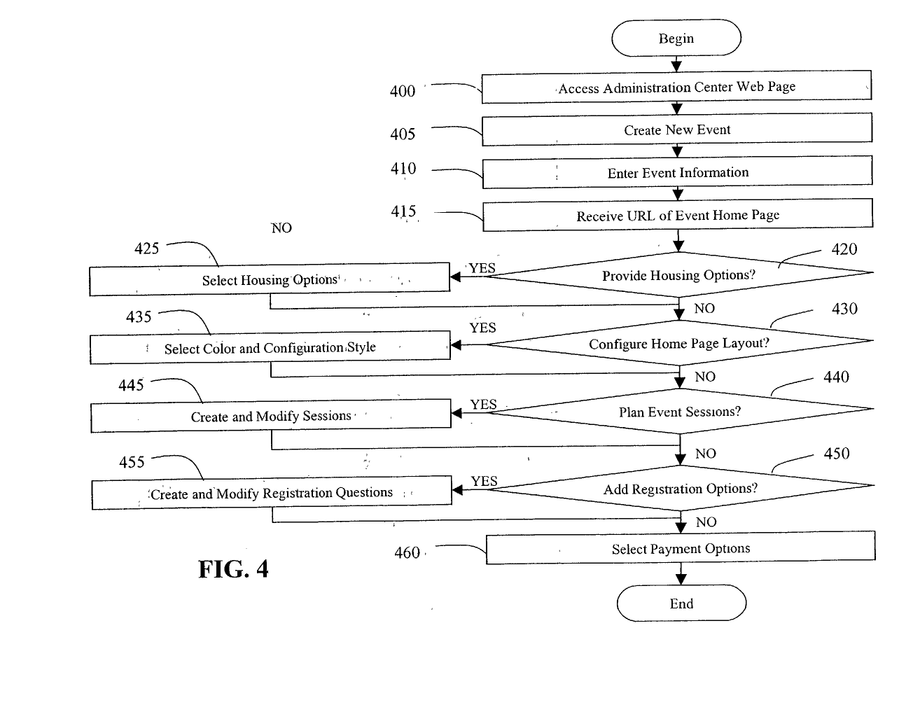

FIG. 4 is a process flow diagram of the steps an event planner takes to create an event using the administration center in accordance with an embodiment of the present invention. An event may include any type of meeting, conference, trade show, seminar, party, wedding, or any other type of gathering. The event creation may be performed by a planner or system administrator, or another user, if desired. In step 400, the planner accesses the administration center Web page. The planner may log on using a username and password. The planner may then create a new event by selecting an appropriate link or button, step 405. The planner may also have access to a plurality of tools and other event management options on the Web page. In step 410, the planner may enter event information such as, for example, the name of the event, the number of attendees, the start and end date, the location and venue, a contact name, email address, phone number of contact person, and any other desired information. In step 415, the planner may receive a URL for the location of the event home page. This URL may be assigned by the event management system. In step 420, the planner may be given the option to provide housing options for the attendees of the event. If the planner chooses to provide housing options, the planner may select housing options, step 425. If not, then the planner may be given the option to configure the home page layout, step 430. In step 435, the planner may be able to select color, style, frame format, graphics, and other configuration options. The planner may then plan event sessions for the event, step 440. If the planner chooses to plan event sessions, the planner may create and modify sessions for the event, step 445. The planner may then have the option to add registration options, step 450, such as adding demographic questions, registration questions, and survey questions, step 455. The planner may then select payment options, step 460, such as determining the cost of the event and how payment may be accepted, if any payment is required.

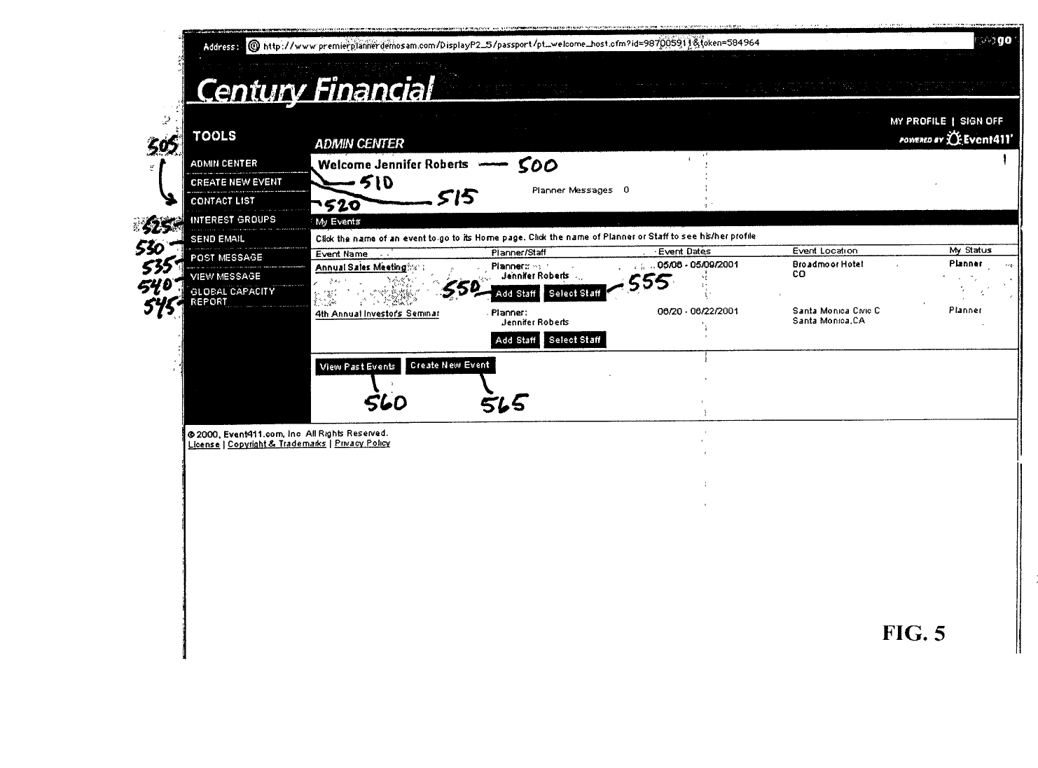

FIG. 5 is an exemplary Web page showing an administration center planner main page in accordance with an embodiment of the present invention. A user may access the administration center planner main page to create new events or view already created events. The administration center planner pages may be associated with the event management module. The event management module may retrieve data from the database to perform operations associated with the administration center pages. The user accessing the administration center may be a system administrator or an event planner. The welcome message 500 identifies the user accessing the event management system. A tools menu 505 includes a selectable list of tool links for some of the tools available to the user including admin center 510, create new event 515, contact list 520, interest groups 525, send email 530, post messages 535, view messages 540, and global capacity report 545. The user may select the add staff button 550 to add staff to work on the event or select the select staff button 555 to select staff from an existing list of staff members to work on the event. The user may select the view past events button 560 to view information on past events or select the create new event button 565 to set up a new event.

To set up the event, the user may enter information about the event and create a personal profile. In an event information section, input fields may include the name of the event, the type of event, the dates of the event, the location, and an indication of whether the event is private or public. The entry of information can be made using either text entry fields, pull-down selection menus, or select buttons. The personal profile section may be used to identify the planner of the event, and the planner may have the information submitted to the database 145 coupled to the event management system server 135. There may be input fields for the planner's name, a user name, password, e-mail address, salutation, job title, company, and address. The user may also elect to receive additional information on a list of services and vendors. The user may then either reset the screen, clearing all fields for a re-entry of information, or submit the information to the database. An enrollment confirmation screen may display the information as entered by the user and assign the user a Uniform Resource Locator (“URL”) where their personal event planning Web site or home page may reside and be accessible to those attending the event. The user can accept the data as being correct, or the user can edit and resubmit the data for correction.

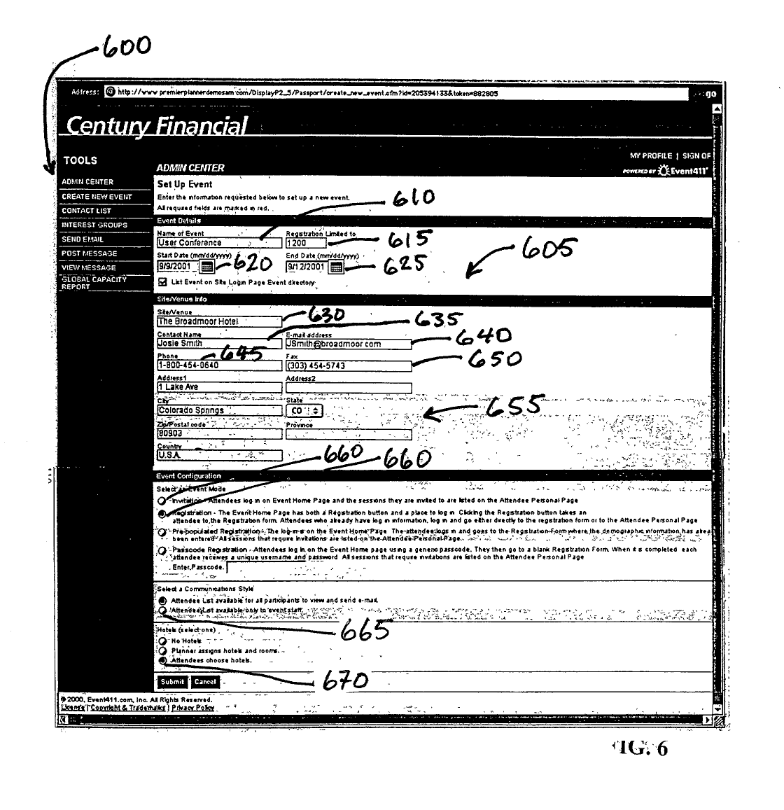

FIG. 6 is an exemplary Web page showing an administration center event set up page in accordance with an embodiment of the present invention. The event set up page includes a tools list 600 and an information input section 605. The user may input event information in input fields including a “Name of Event” field 610, “Registration Limited to” field 615, defining the maximum number of attendees, a “Start Date” field 620, an “End Date” field 625, a “Site/Venue” field 630, a “Contact Name” field 635, an e-mail address of the contact person in the “E-mail address” field 640, a “Phone” field 645, a “Fax” field 650, and address fields 655. The user may select the mode configuration of the event from select boxes 660 to determine whether the event is in invitation mode, where attendees are notified of the event when they log onto an event home page, a registration mode, where users are given an option of either logging into the system or registering for the event, a pre-populated registration mode, where users log in and go to the registration form, and a passcode registration, where users log on to the event home page using generic code and receives a unique username and password upon registering for the event. The user may also select a communications style from communications style select boxes 665 to determine whether the attendee list is available to everyone participating in the event or only the staff working on the event. The user may select housing accommodations from hotel select boxes 670 depending on whether hotel rooms are provided or if the attendee must choose their own hotel.

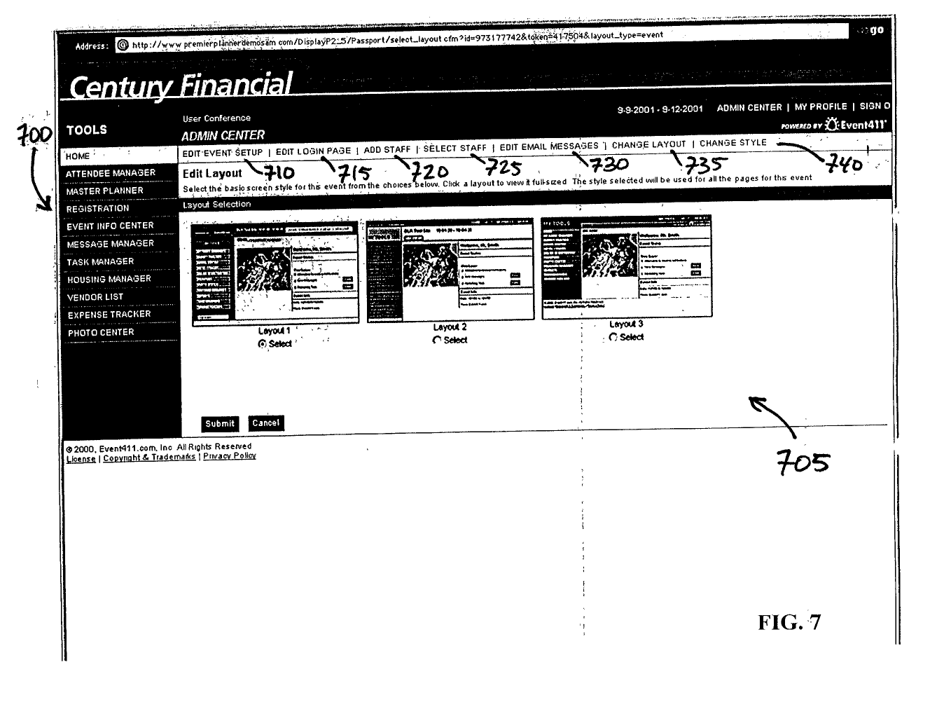

FIG. 7 is an exemplary Web page showing an administration center event home-page layout creation page in accordance with an embodiment of the present invention. The home-page layout creation page includes a tools list 700 and a layout selection area 705. A tool bar may also appear including select links to other tools where the user may edit the event setup 710, edit the logon page 715, add staff 720, select staff 725, edit e-mail messages 730, change the layout 735, and change the page style 740. The user may select from the provided layout styles. A full-size view of the layout selected may be viewed for more detail before selecting. A user may also configure the style of the event home page by selecting colors for the frames and headers in the home page, import graphics for the home page, and make any other desired style selections.

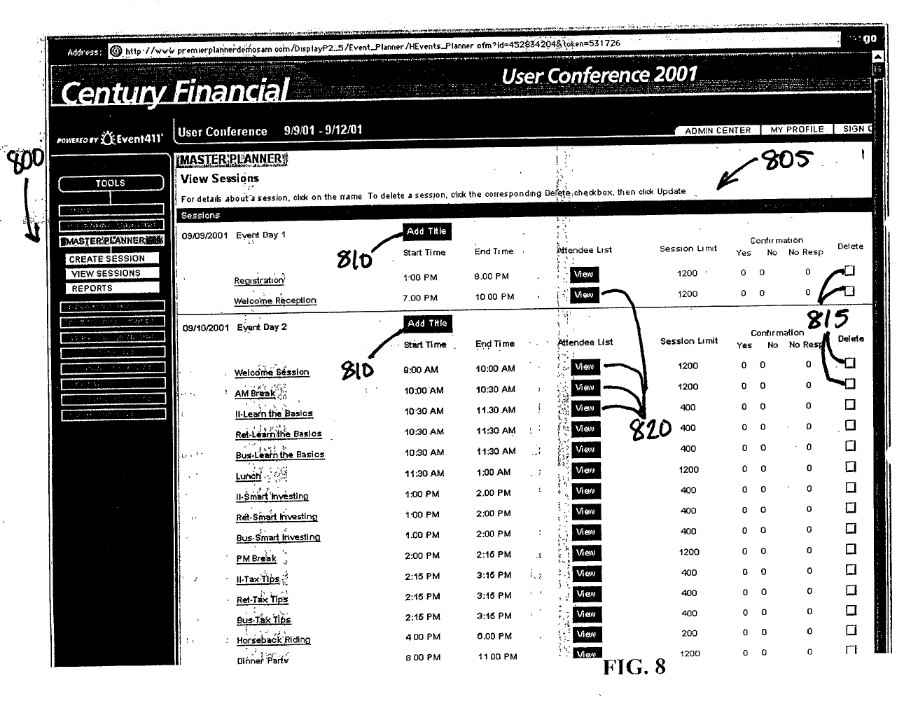

FIG. 8 is an exemplary Web page showing an administration center master planner page in accordance with an embodiment of the present invention. The master planner page includes a tools list 800 and a session modification area 805. The tools list 800 includes links to other tools including home, attendee manager, master planner, the submenu of master planner including create session, view session, and reports links, registration, event info center, message manager, task manager, housing manager, vendor list, expense tracker, and photo center links. The user may select the “Add Title” button 810 to add a session to a particular day of the event. The user may select delete check boxes 815 to select sessions to be deleted from the event. The user may further view the attendee list of any of the sessions by selecting the corresponding “View” button 820. When adding a session, the user may be required to provide information on the session including, for example, a session name, a session maximum capacity, a start date and end date, a begin time and end time, and information on the location of the session.

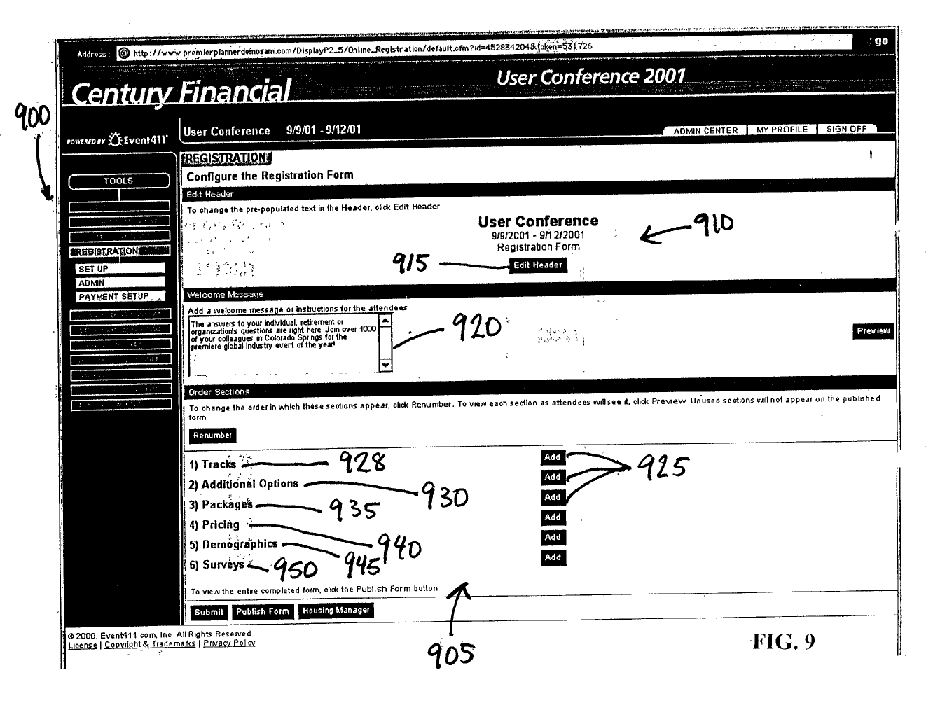

FIG. 9 is an exemplary Web page showing an administration center registration form configuration page in accordance with an embodiment of the present invention. The registration form configuration page includes a tools list 900 and a configuration area 905. The user may use this page to determine the format of the registration page that attendees may complete to attend the event. The page shows the header 910 of the registration form which may be changed by selecting the “Edit Header” button 915. The user may create and edit a welcome message in the welcome message text entry field 920. The user may select the corresponding “Add” button 925 to add multiple tracks to the event 928, add additional options 930, add packages 935, add pricing 940, add demographic fields 945, and add surveys 950 to the registration form. The user may elect to have different pricing options depending on how early a person registers for the event. Demographic fields may include, for example, organization affiliated with, address, e-mail address, phone numbers, airline traveled on, age, and any other information desired by the user. Additionally, the user may create survey questions that they want attendees to answer to acquire additional information on those attending the event. Payment options may also be selected, including on-line credit card payment.

Similarly, the user may configure a home page for the event using similar tools and options as those described above in configuring the registration form. Configuration tools allows the user to create a visual style for the event home page. The planner may add photos or graphics to the home page and compose a message that will appear on all of the attendees' personalized home pages.

Additionally, a guest invitation system may be included which allows the planner or administrator of the event to create a list of potential attendees for a particular event. The system could then send e-mails to each person invited to the event, the e-mail including information about the event. The e-mail may also contain a URL of a Web site where the potential attendee can register for the event, access their personalized home page, and access event management tools.

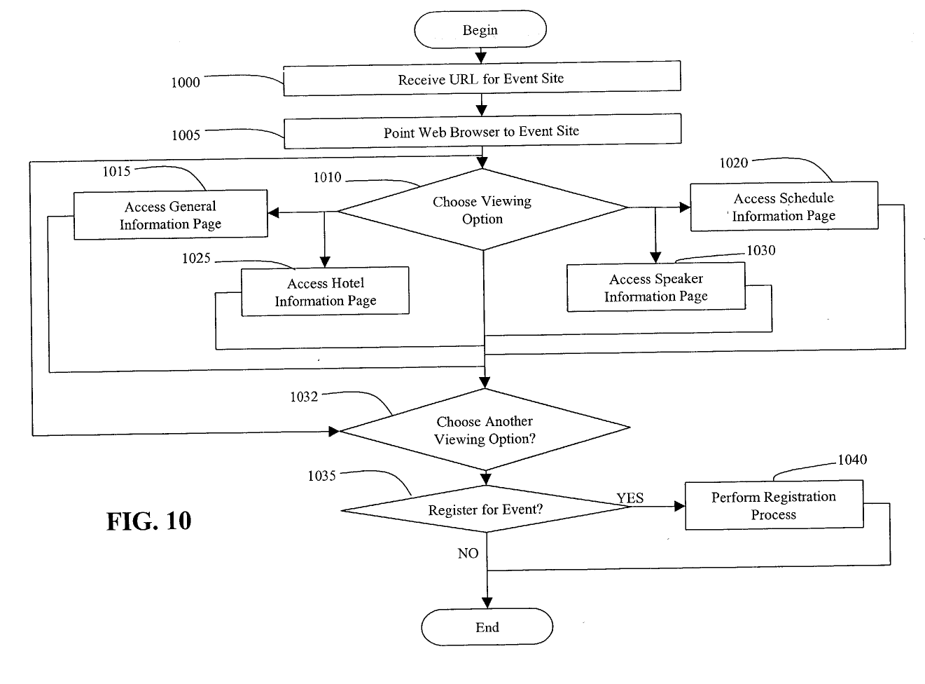

FIG. 10 is a process flow diagram of the steps a user takes to use the event info center in accordance with an embodiment of the present invention. In step 1000, the user receives a URL of a home page for the event Web site. The user may point a Web browser to the event Web site, step 1005. The user may then view a page having information on the event. The user may then have a choice of a plurality of pages having event information, step 1010. Four viewing options are illustrated in FIG. 10, however, any desired number of viewing options may be included in the Web site. In step 1015, the user may access the general information page. In step 1020, the user may access the schedule information page. In step 1025, the user may access the hotel information page. In step 1030, the user may access the speaker information page. The user may return to step 1010 and choose to view another viewing option, step 1032. The user may have the option to register for the event, step 1035. The user may register after viewing information pages, as illustrated in FIG. 10. Alternatively, the user may register for the event before viewing the information pages or without viewing the information pages. In step 1040, the user may perform the registration process by completing registration pages.

Using the event info center, the planner can upload detailed event information including text, graphics, and images to the event Web site. Once the information has been uploaded, the attendee's can access this information from one place at the event Web site URL, as described with reference to FIG. 10. The event info center pages are associated with an event info center module on the event management system server. The event info center module may retrieve data from the database to perform operations associated with the event info center.

Using the event info center the planner can create a main page or “online brochure” for the event they are planning. This page can contain any number of pages of detailed event information such as session information, hotel information, speaker information, and the like. The planner can choose from a plurality of different page templates for the event info center. In addition, the planner can choose from four prefabricated pages or create their own custom pages, however, any number of prefabricated pages may be provided. The four prefabricated pages include general information, hotel information, schedule information, and speaker information. Each page may contain text, images, a header, sponsor logos, graphics and/or images. The planner can create new pages at will and make information available to the attendees at anytime. Modifications to the information can be made at anytime and may appear on the event Web site page when the planner chooses to make the information available. One advantage of the event info center is that prefabricated forms allow a planner to quickly and easily update information without needing any knowledge of HTML, Web page design, or any programming language. Another advantage of the event info center is that information may be dynamically updated when a planner or administrator updates event information on the event management system. This includes changes made using other tools on the event management system.

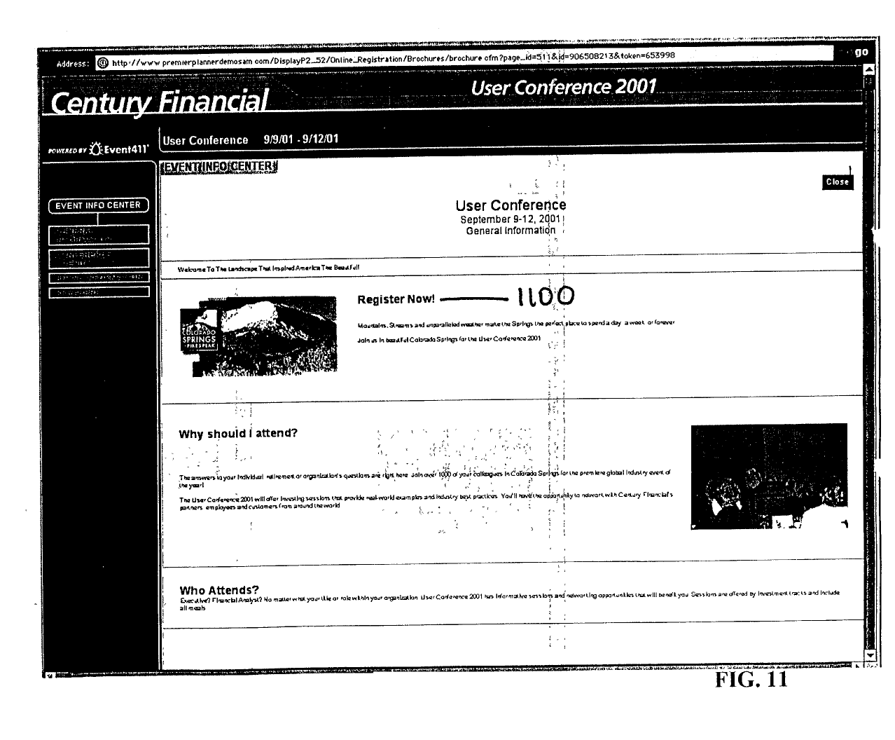

FIG. 11 is an exemplary Web page showing an event info center general information page in accordance with an embodiment of the present invention. The general information page allows the planner to add information such as attire, weather information, maps, directions, and the like. The page may include a link 1100 for a user to register for the event. The page may also include an event info center link list having links to other info center pages including a general information link, conference agenda or schedule information link, hotel information link, and speaker information link.

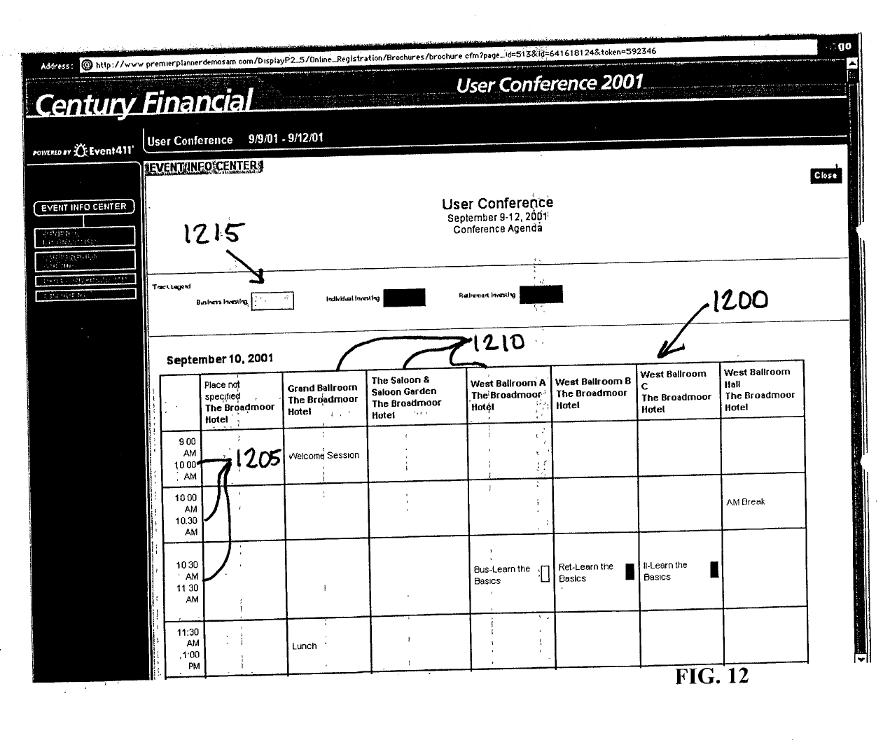

FIG. 12 is an exemplary Web page showing an event info center schedule information page in accordance with an embodiment of the present invention. The schedule information page may be dynamically created based on the sessions of the event selected or modified by a planner or administrator of the event. The schedule information page is a graphical representation of sessions that may include track information. The page may show the attendee which sessions occur at what time, and which sessions overlap. In the page illustrated in FIG. 12, a schedule grid 1200 includes the times of sessions 1205 and the location of the session 1210 at the event. The page may include a legend 1215 to indicate information about the sessions.

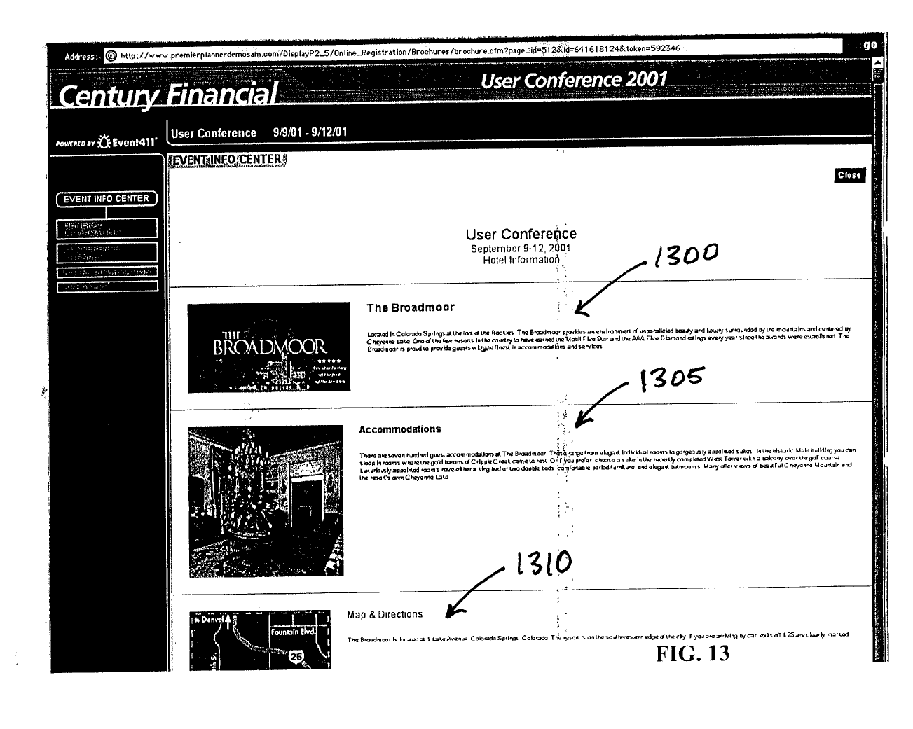

FIG. 13 is an exemplary Web page showing an event info center hotel information page in accordance with an embodiment of the present invention. The hotel information page gives the planner the ability to post detailed hotel information 1300, including available rooms, amenities and accommodations 1305, and pricing information. Maps and directions 1310 may also be included.

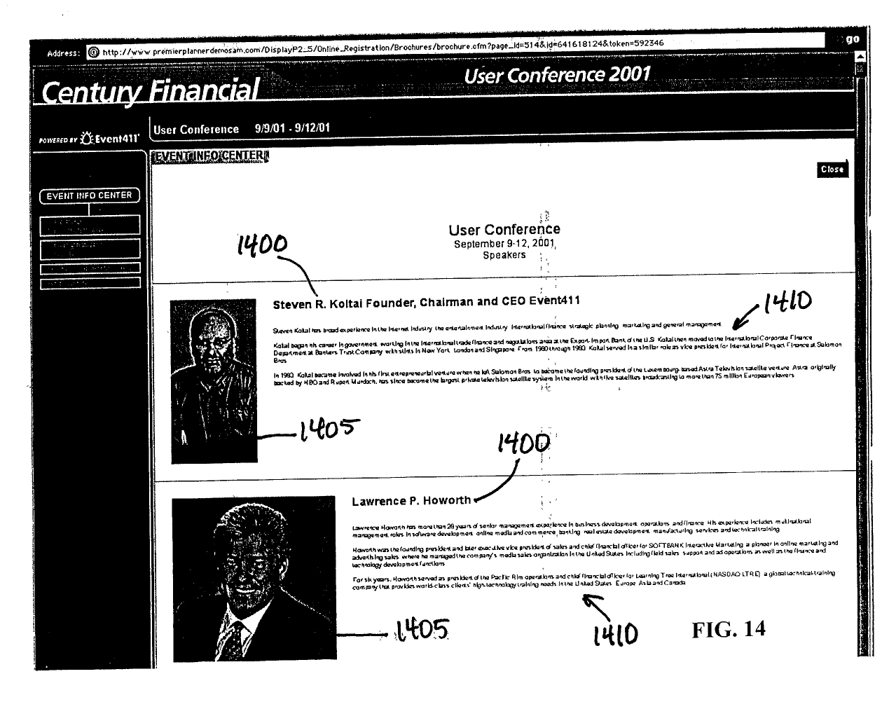

FIG. 14 is an exemplary Web page showing an event info center speaker information page in accordance with an embodiment of the present invention. The speaker information page allows the planner to post detailed speaker information including each speaker's name 1400, their picture 1405, and an abstract and biography 1410.

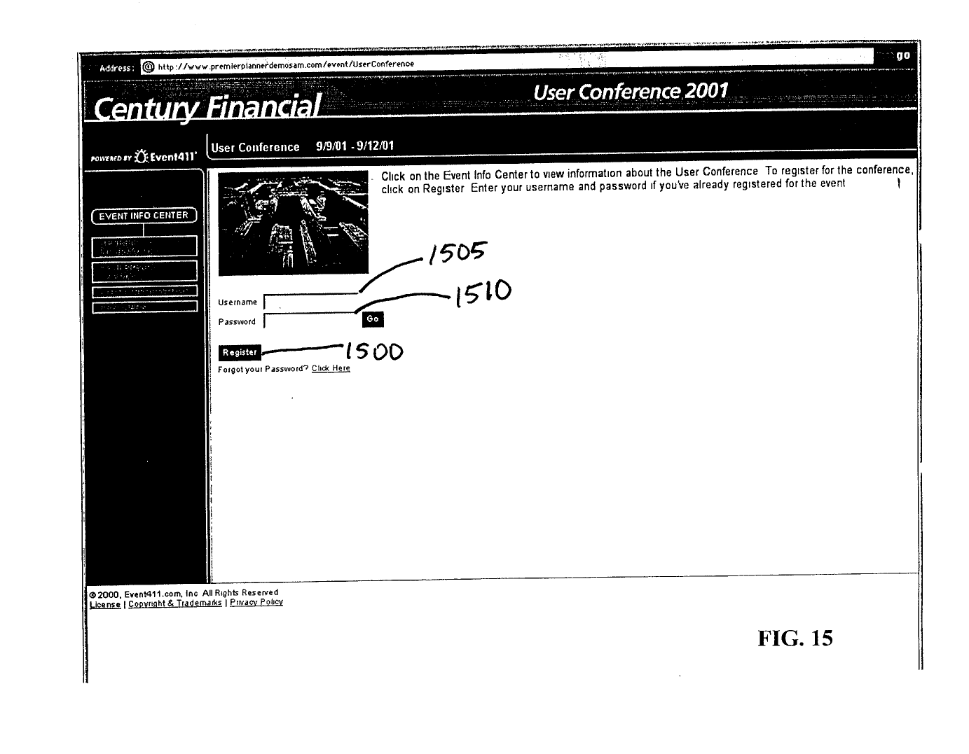

FIG. 15 is an exemplary Web page showing a event registration page in accordance with an embodiment of the present invention. A user may select the register button 1500 to register for the event or, if the user is already registered, the user may enter their username and password into the username field 1505 and password field 1510, respectively, to access the event Web page.

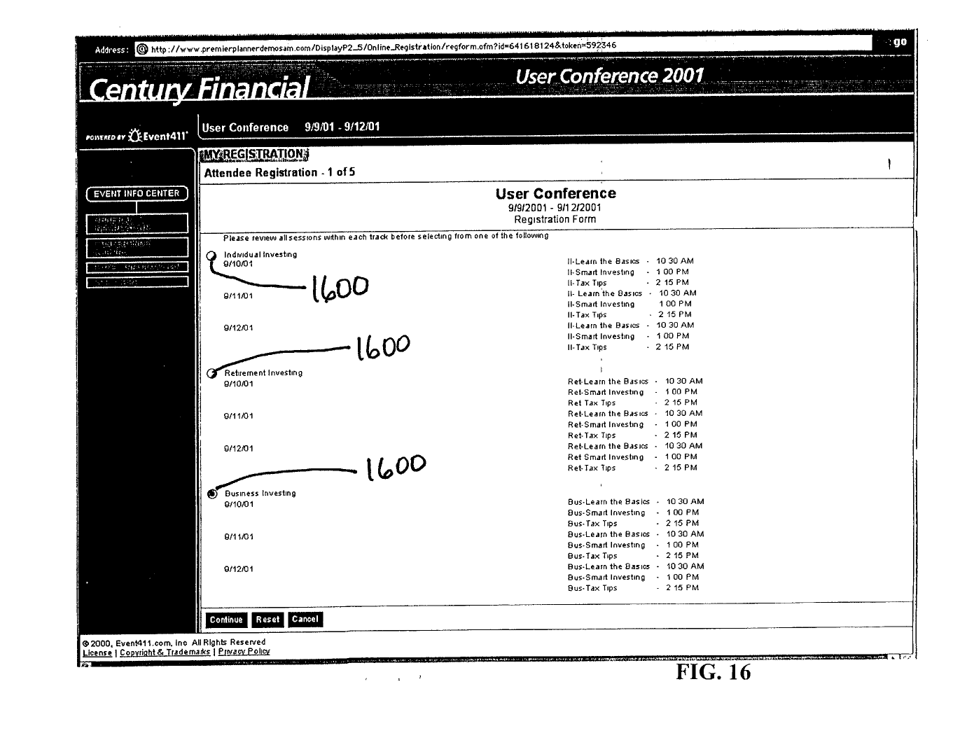

FIG. 16 is an exemplary Web page showing an event registration event selection page in accordance with an embodiment of the present invention. Upon registering for the event, a list of sessions and activities is shown on the page. The user may select sessions or activities to attend during the event from select boxes 1600.

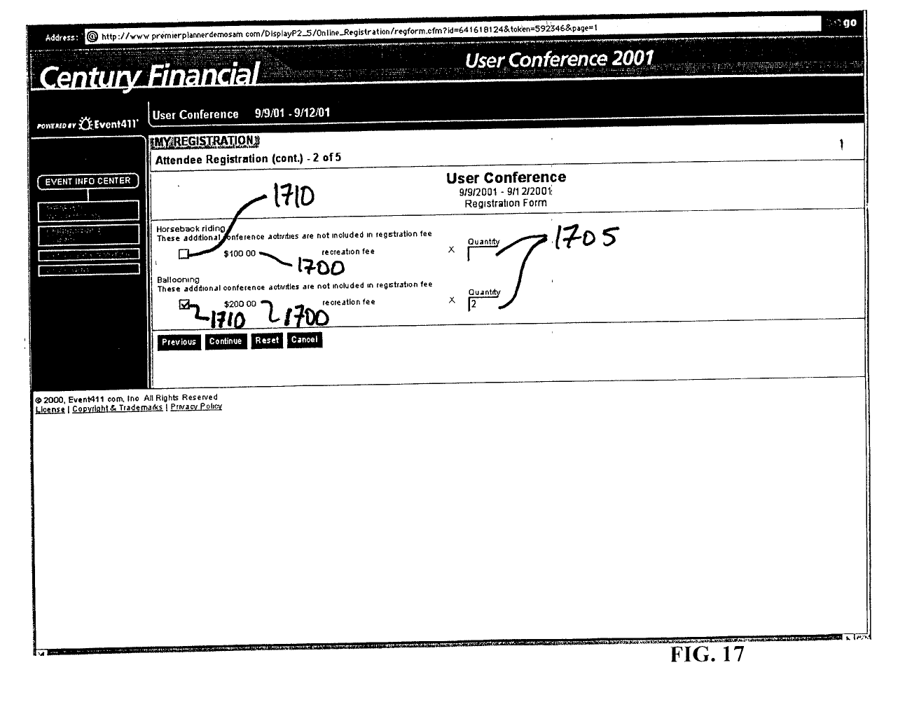

FIG. 17 is an exemplary Web page showing an event registration activity selection page in accordance with an embodiment of the present invention. Additional activities may be shown including the cost 1700 of the activity, a quantity input field 1705 to indicate the number of participants, and select check boxes 1710 to add the activity to the user's schedule.

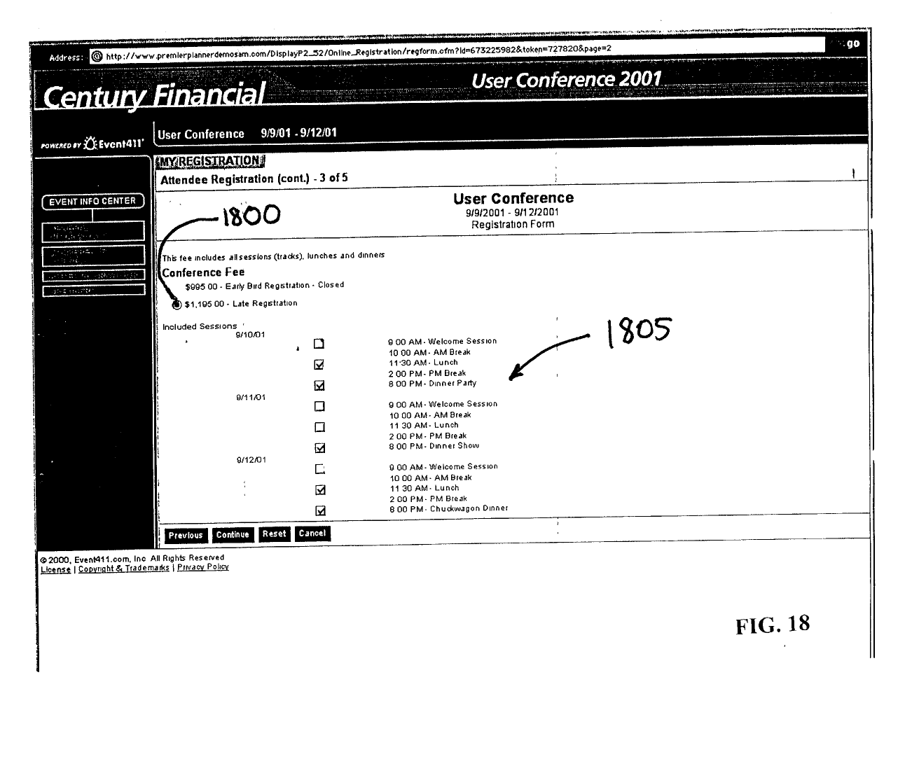

FIG. 18 is an exemplary Web page showing an event registration conference fee selection page in accordance with an embodiment of the present invention. The user may select the payment option from select check boxes 1800, if options are available. The payment selection page may show indicated, in a list of sessions 1805, those sessions which are included in the selected registration fee.

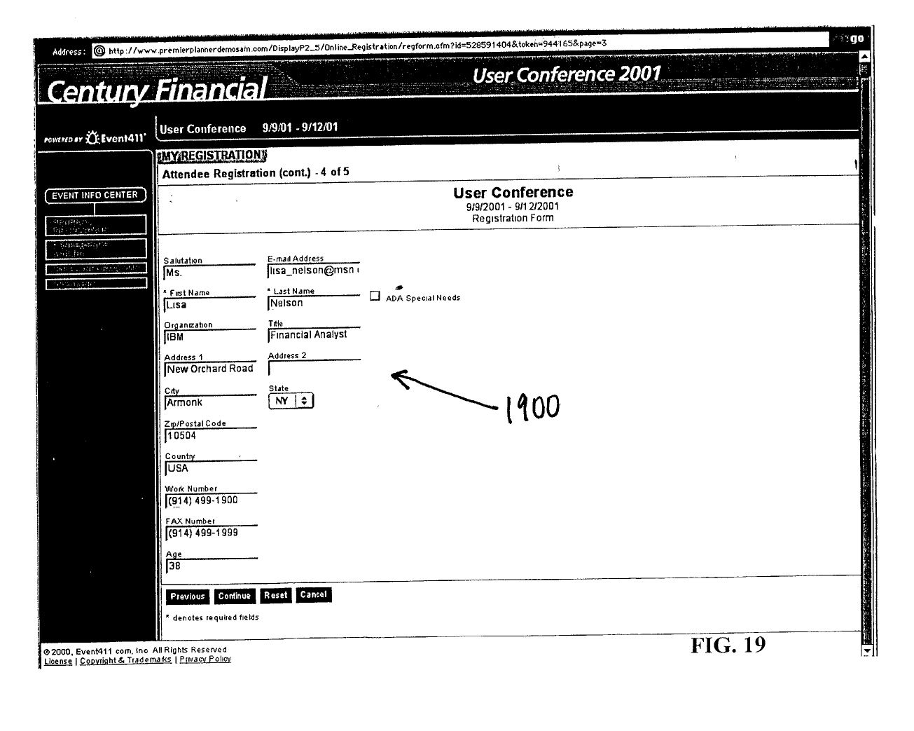

FIG. 19 is an exemplary Web page showing an event registration attendee information page in accordance with an embodiment of the present invention. A user may be required to enter their personal information in information fields 1900 to register for the event.

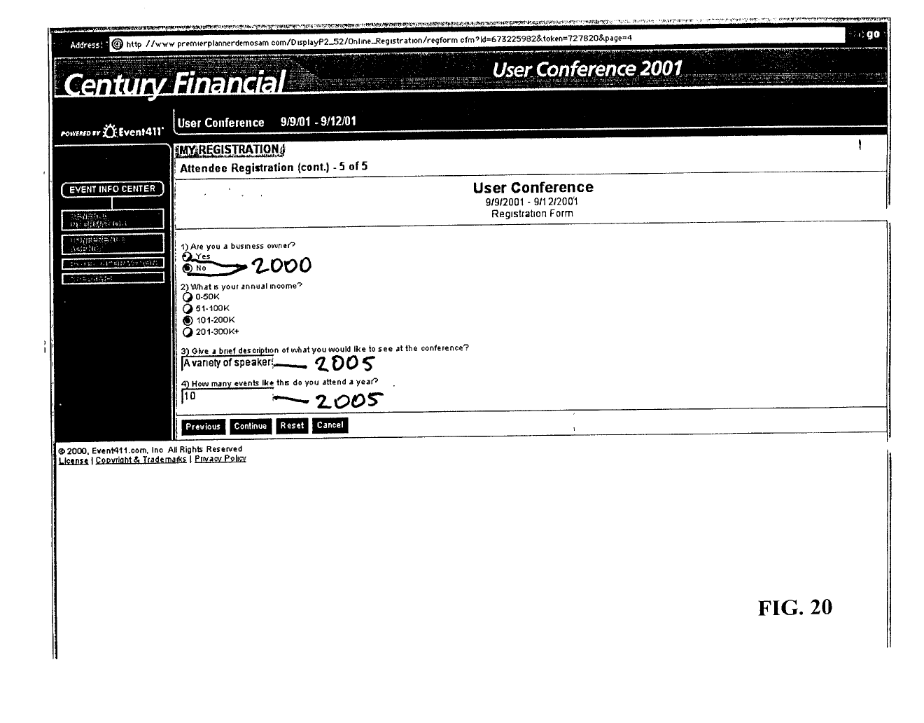

FIG. 20 is an exemplary Web page showing an event registration survey page in accordance with an embodiment of the present invention. The user may answer registration survey questions by selecting answers from check boxes 2000 or entering answers in text entry fields 2005.

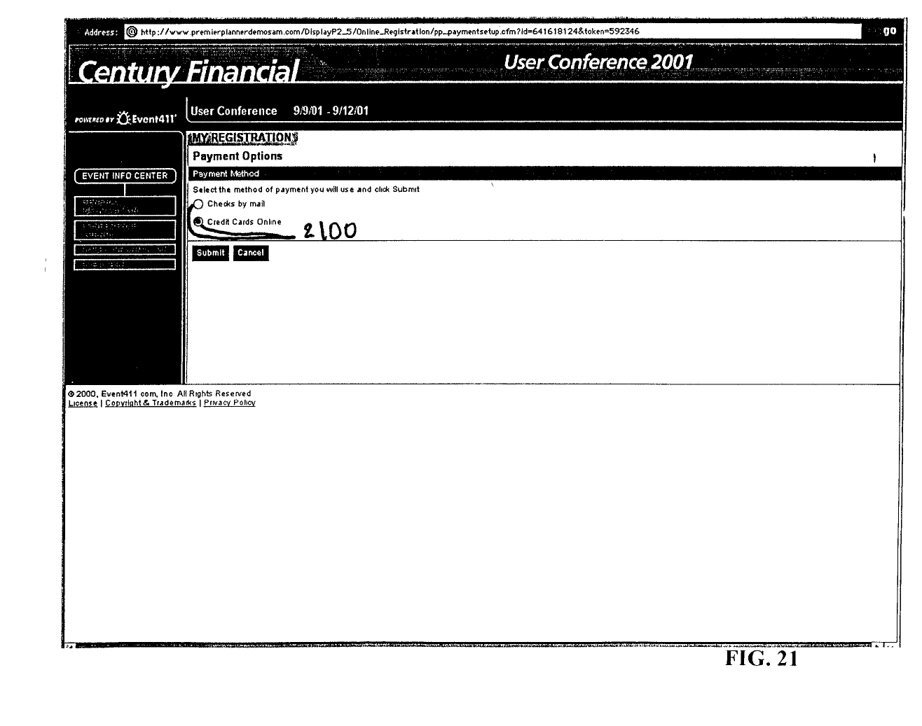

FIG. 21 is an exemplary Web page showing an event registration payment selection page in accordance with an embodiment of the present invention. The payment selection page includes select check boxes 2100 for the user to indicate a method of payment for attending the event.

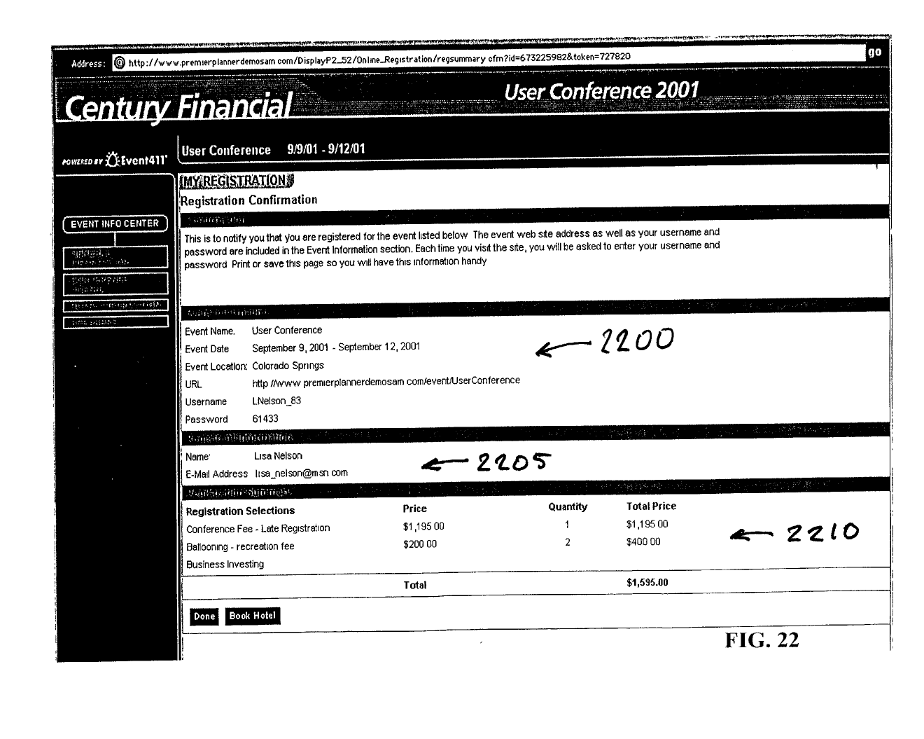

FIG. 22 is an exemplary Web page showing an event registration confirmation page in accordance with an embodiment of the present invention. Upon completing the registration, the user will view a registration confirmation page. The page may include event information 2200, registrant information 2205, and a summary of the registration 2210.

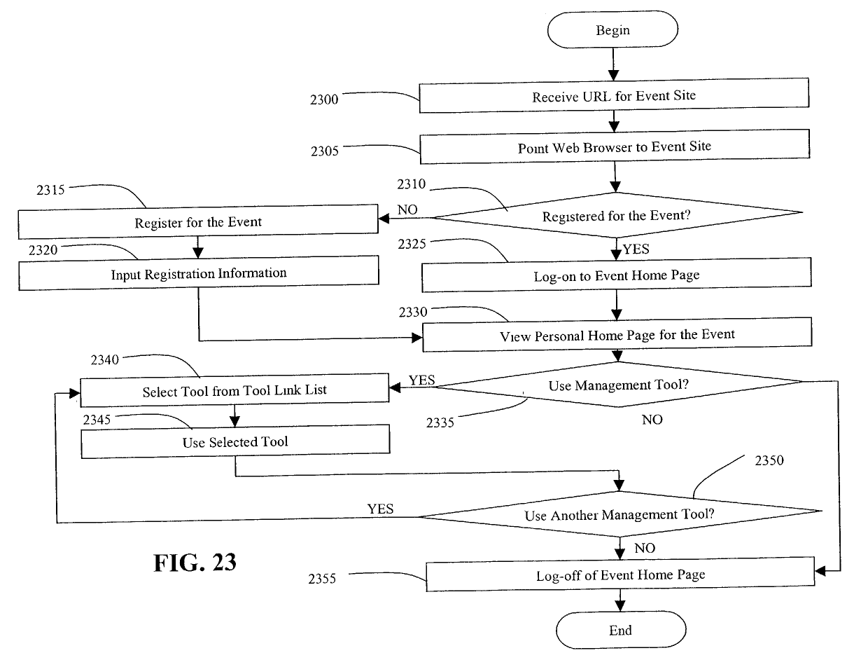

FIG. 23 is a process flow diagram of the steps an user takes to access the event management tools. In step 2300, the user will receive a URL for the event home page Web site. The user may then point a Web browser to the event Web site, step 2305. In step 2310, the user has an option depending on whether the user is already registered for the event. If the user is not registered, the user may proceed to register for the event, step 2315, where the user may input registration information 2320 in at least one registration page. If the user is already registered, the user may log-on to the home page, step 2325. In step 2330, the user may view the personal home page for the event. In step 2335, the user has the option to use event management tools. If the user chooses to use a management tool, the user may select a tool from a tools link list on the home page, step 2340. The user may then view pages allowing the user to use the selected management tool, step 2345. The user will have the option to use another management tool, step 2350. Otherwise, the user may log-off of the event home page, step 2355. The operation of the various tools is described below.

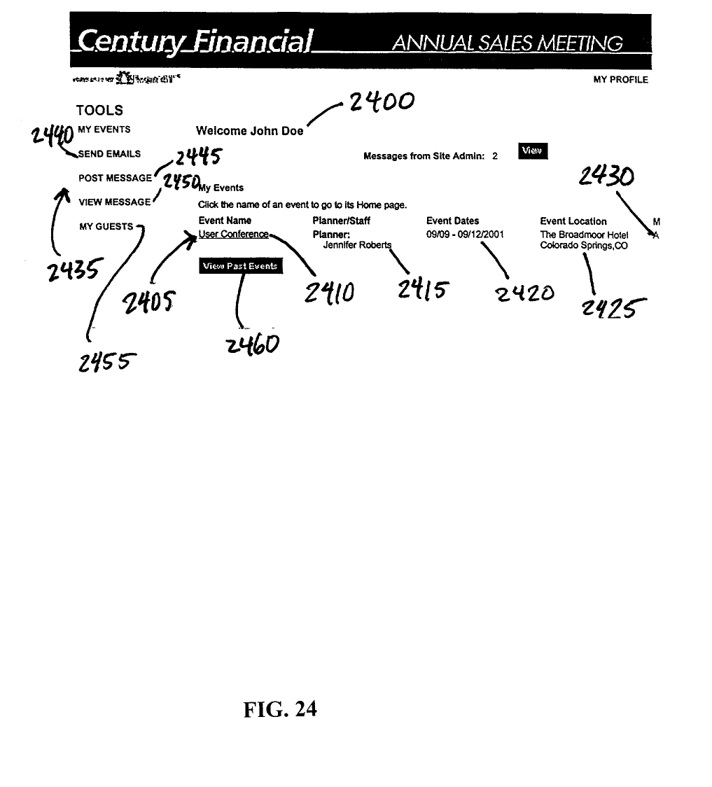

FIG. 24 is an exemplary Web page showing an event user welcome page in accordance with an embodiment of the present invention. The user may access their personalized welcome page where the user has access to a set of event planning tools, including, but not limited to, the task management module, expense tracking module, event info center module, and personalized management module. Each of the engines may be configured to process the respectively associated tools. From the welcome page, the user may access personal home pages for particular events and create and edit their home page for the events. An administrator or planner may be able to change the home page screen that will be viewed by each event attendee, assign tasks to attendees, chose the visual style that attendees will see, import graphics and photos that will be accessible by attendees, and set up other features of the home page.

Referring now to FIG. 24, after logging on, the user, identified by name 2400, may view a list of the user's events 2405. Through this home page, a user may have access to a plurality of pages and tools that the user may access to manage event related tasks and responsibilities. The user can view the name of the event 2410, the name of the planner or staff managing the event 2415, the event dates 2420 during which the event takes place, the event location 2425, and the user's status 2430. The user's status may indicate whether the user is an attendee, planner, administrator or involved in some other capacity. A tools links menu 2435 may appear for the user to access in managing participation in the listed events. Available tools from the event pages can include sending e-mails 2440, posting messages 2445, viewing messages 2450, and managing personal guests 2455. A user may also choose to view a list of the past events that the user has attended by selecting the “View Past Events” button 2460. Using a pointer and clicking, or selecting, on the name of the conference 2410 in the list of event names, a link to information on the event, will direct the user to the user's personalized home page for the particular event.

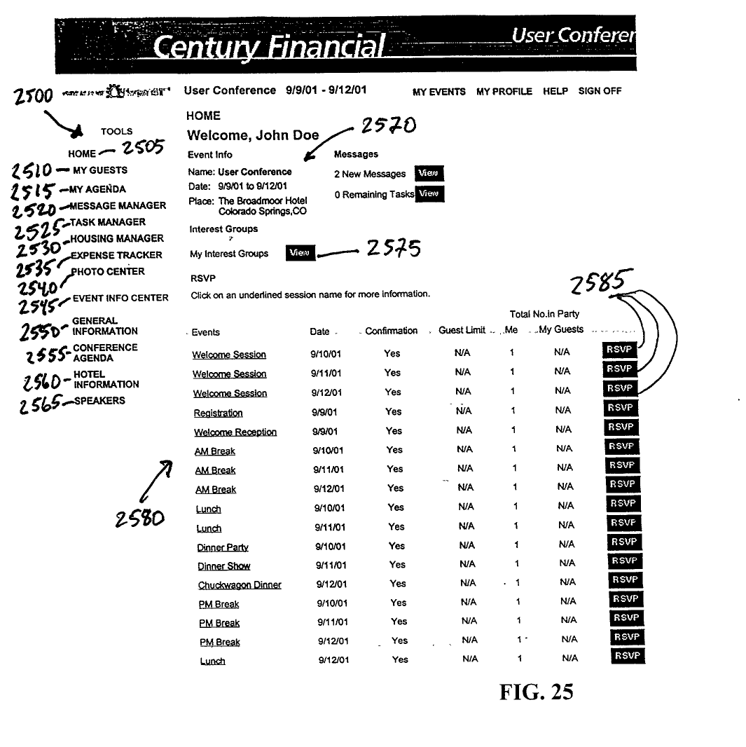

FIG. 25 is an exemplary Web page showing a user's personalized event home page in accordance with an embodiment of the present invention. The user personalized event home pages are associated with the personalized management module. The personalized management module retrieves data from the database to perform operations associated with the personalized event home page. A tools menu 2500 may appear on the page. At any time, the user may use the tools buttons to return to the user's personalized home page for the particular event 2505, access guest management tools 2510, access an agenda 2515, access a message manager 2520, access task management tools 2525, access a housing manager 2530, access an expense tracking management module 2535, access photo center tools 2540, access the event info center 2545, access general information on the event 2550, access a conference agenda 2555, access hotel information 2560, and access information on speaker at the event 2565.

Information displayed on the user's personalized home page may include event information 2570, including the name, date and place of the event, and an indication of how many messages and remaining tasks the user has. The user may select an interest group “View” button 2575 to view interest groups. A list of activities and sessions for the event 2580 appear on the page, and the user may select a corresponding “RSVP” button 2585 to access a page where the user can RSVP to particular activities.

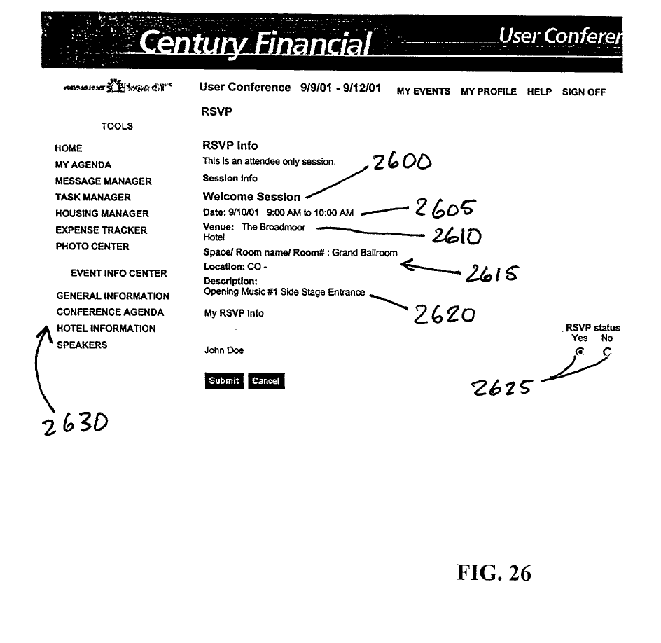

FIG. 26 is an exemplary Web page showing a RSVP page in accordance with an embodiment of the present invention. The RSVP page displays information on the particular activity or session including, but not limited to, the title of the activity 2600, date and time of the activity 2605, venue 2610, location 2615, and description of the activity 2620. On an RSVP page the user may choose the RSVP status as either yes or no using “RSVP status” select boxes 2625. The RSVP page may also include tools link lists 2630.

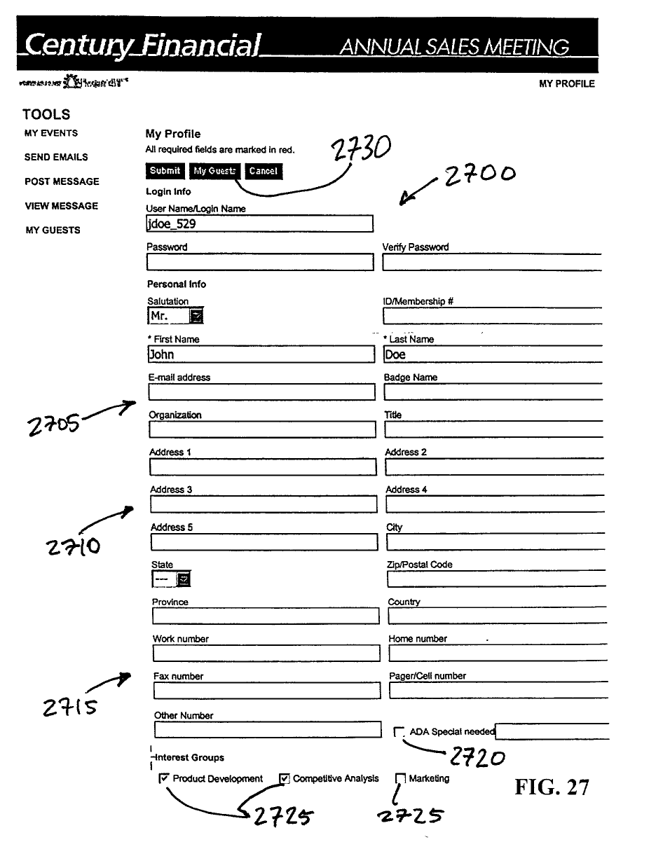

FIG. 27 is an exemplary Web page showing a user profile page in accordance with an embodiment of the present invention. On the user profile page, the user may enter or update user information into text entry fields including login information 2700, name and personal information 2705, addresses 2710 and phone numbers 2715, and an indication of any special needs 2720. The user may select interest groups from interest group select boxes 2725. The user may also select a “My Guest” button 2730 to access the guest management tool.

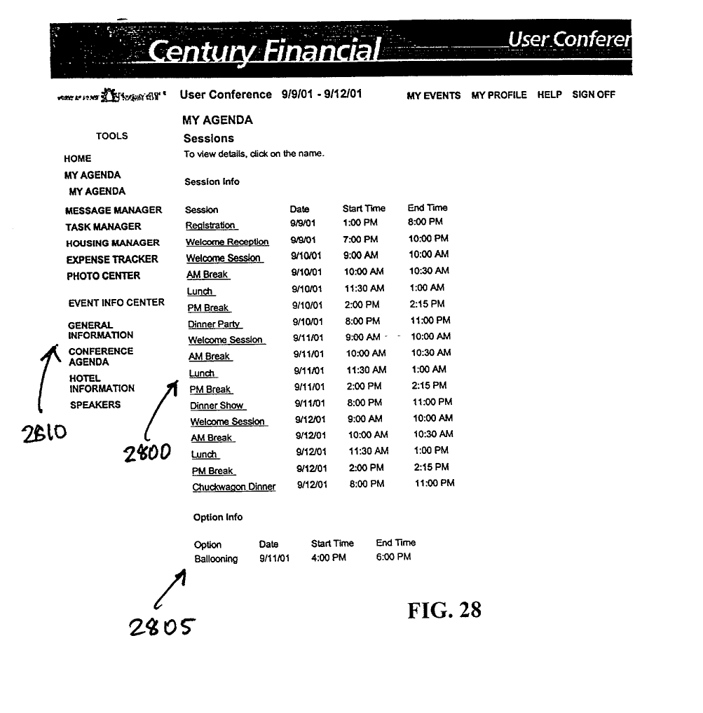

FIG. 28 is an exemplary Web page showing a user agenda page in accordance with an embodiment of the present invention. On the user agenda page, the user may view a list of sessions 2800 that the user may attend as well as optional activities 2805 that the user may participate in. By selecting on the name of a particular session the user can link to an agenda page for a specific session. The user agenda page may include tool link lists 2810.

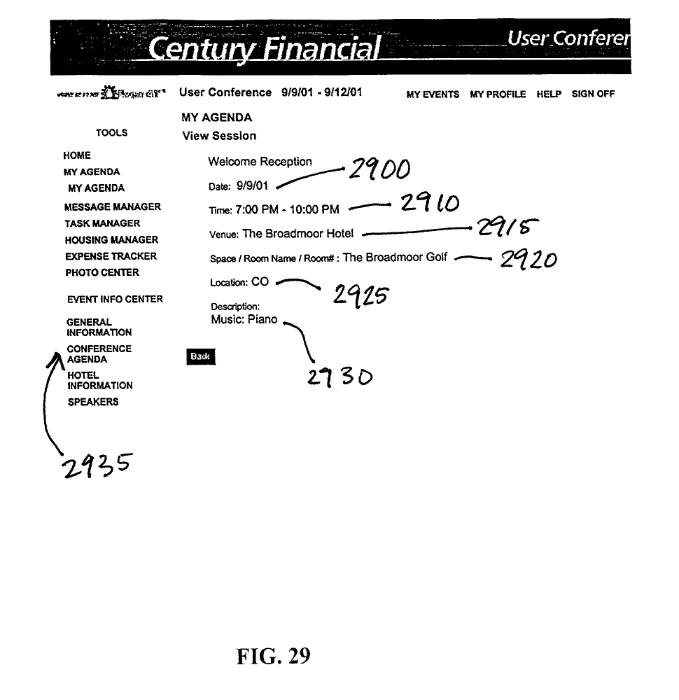

FIG. 29 is an exemplary Web page showing a user agenda page for a specific session in accordance with an embodiment of the present invention. The agenda page may include details regarding the specific session selected from the user agenda page including the date 2900, time 2910, venue 2915, room number 2920, location 2925, and description 2930. The user agenda page for a specific session may also include tool link lists 2935.

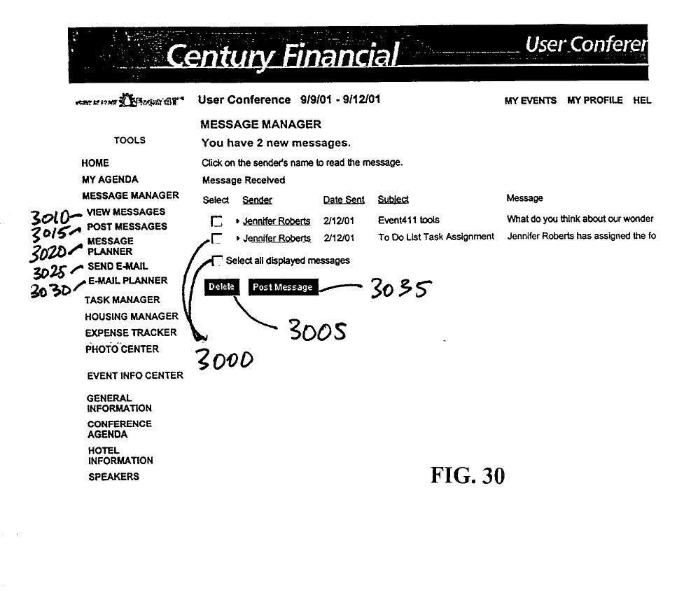

FIG. 30 is an exemplary Web page showing a message manager view message page in accordance with an embodiment of the present invention. A message management system allows the user to view messages sent by other attendees, administrators, planner, or other participants of the event. The user may view all of the messages or read individual messages by selecting the name of the sender. The user my place a check in the select box 3000 and use a delete button 3005 to delete selected messages. Upon selecting the message management system, a sub-menu may appear in the tools menu that allows a user to view messages 3010, post messages 3015, access the message planner 3020, send e-mail 3025, or access the e-mail planner system 3030. A user may also post messages by selecting a post message button 3035.

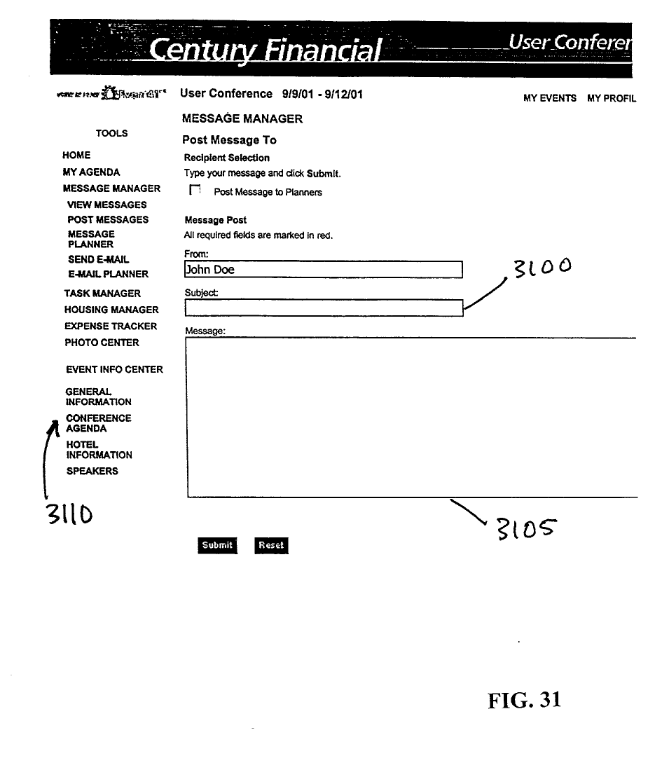

FIG. 31 is an exemplary Web page showing a message manager post message page in accordance with an embodiment of the present invention. A message posting system allows the user to select the recipient of the message, draft the subject 3100 and the message 3105 in text entry boxes, and submit or reset the message. The post message page may also include a tool link list 3110.

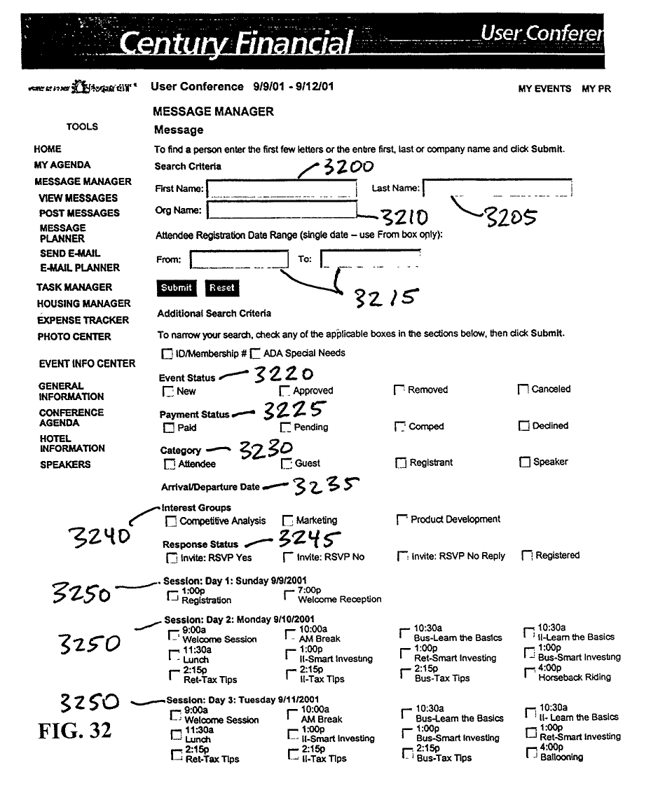

FIG. 32 is an exemplary Web page showing a message manager user search page in accordance with an embodiment of the present invention. The user can enter search criteria in the user search page to locate the user name of a person or persons to send a message to. The user may enter search criteria into fields including first name 3200, last name 3205, organization name 3210, or registration dates 3215. The user may also select specific criteria from select boxes in particular categories including event status 3220, payment status 3225, category 3230, arrival/departure date 3235, interest group 3240, response status 3245, and sessions being attended during a particular day 3250. The user search page may also include tool link list 3210.

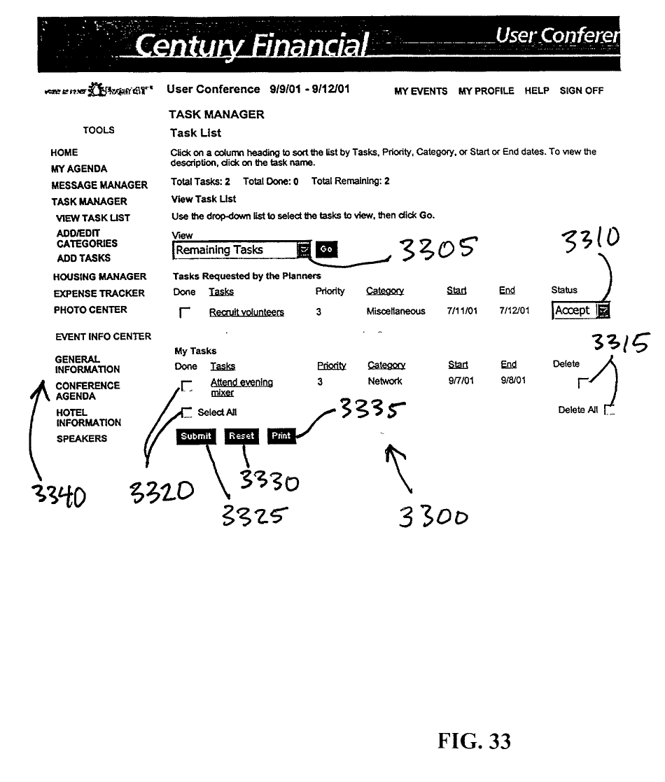

FIG. 33 is an exemplary Web page showing a task manager task list page in accordance with an embodiment of the present invention. By default, the entire list of tasks may appear sorted by category in a task list area 3300. From this screen the user may organize the lists of tasks by selecting a particular predetermined view from the view pull-down menu 3305. Predetermined views include viewing remaining tasks, completed tasks, and all tasks. A user may perform a keyword search to view only those tasks that contain or are associated with the particular keyword or keywords searched. After entering a word, name, or any other string of letters as a search parameter, those tasks most closely related to the search term will appear at the top of the task list. The user may also sort their list of tasks by completion status, task name, category, due date, or the person who assigned the task.

The user may select to accept or decline an assigned task by selecting from the Status pull down menu 3310. The user may select delete check boxes 3315 associated with tasks that the user wants to delete. The user may also select done check boxes 3320 when the user has completed the task. Upon making these selections, the user may select the submit button 3325 to have the task list updated, select the reset button 3330 to have the fields reset, or select the print button 3335 to have the task list printed out. The user may also select the name of the task to link to a page having additional information on the assigned task, such as category, date assigned, and the option of cancelling the task.

The user may develop and manage their own task list using the sub-menu tools and adding categories and tasks from the tool link list 3340. The user may also edit or delete the categories once they are created. The user may add, delete, and edit categories on an add/edit categories page. After creating categories, the user may create tasks on the add task page by entering a task description, choosing a priority from a pull-down menu, choosing the proper category to associate the task with, and entering required date information.

The user may assign tasks to a person or a group of persons. The user may select a task to be assigned, a group name, and a label. A text box can be produced with a list names based on the group and label selections. From this text box the user may add names to or removes names from an assignment text box. After the user selects the submit button, the persons named in the assignment text box may become assignees of this particular task.

The task manager tool is accessible by all users involved with the event. Attendees may use the task manager to manage their own tasks, and those that have been assigned to them, and planners or administrators who are coordinating the event may use the task manager to effectively delegate responsibilities. Using the task management module, the planner or administrator can efficiently and effectively manage tasks associated with planning a complex event such as a wedding, convention, or exposition. Alternatively, the user may use the task manager to manage their own event-related tasks and coordinate with the event planner.

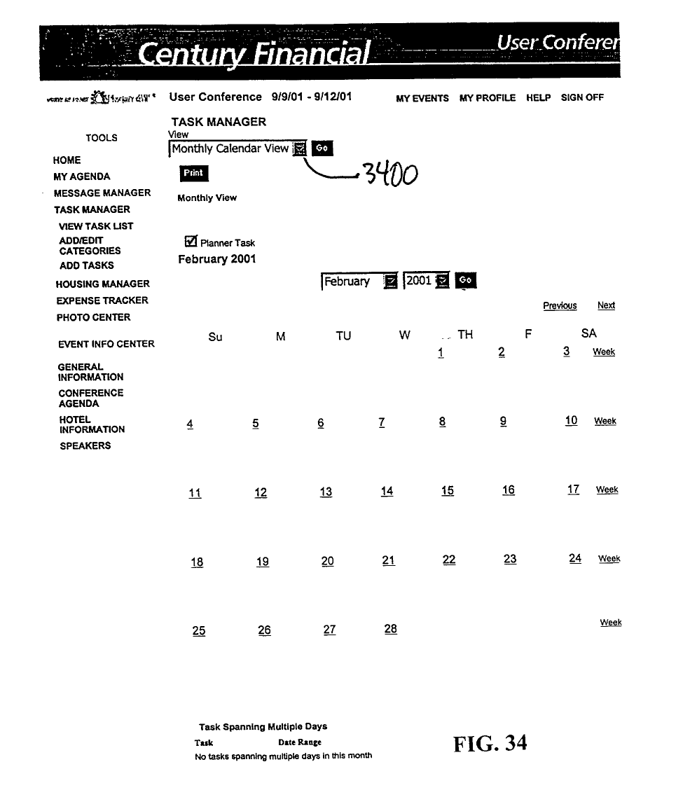

FIG. 34 is an exemplary Web page showing a task manager monthly calendar view page in accordance with an embodiment of the present invention. The user may select other view options from the view pull-down menu 3400 including a monthly calender view, a weekly calender view, a daily calender view, and a printable view. All the tasks associated with the selected time period will be displayed. The user can select a particular day to view more detail on tasks items for that particular day. The user may select buttons allowing the user to view the next or previous month, week, or day of tasks. The user may perform add, remove, edit, assign, or other functions from any of the selected views. The user may also scroll up or down on the screen to see the complete list of tasks. In the daily view, the user may select a span icon to view tasks that span over an specified period of days.

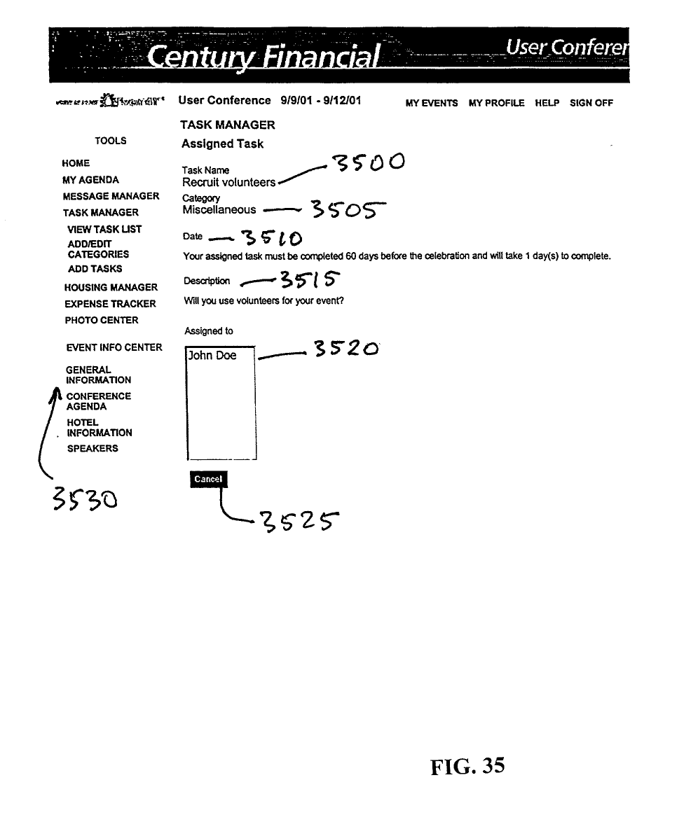

FIG. 35 is an exemplary Web page showing a task manager task detail page in accordance with an embodiment of the present invention. The task detail page may include detail regarding a selected task including, but not limited to, task name 3500, task category 3505, task date 3510, task description 3515, and the person or persons to whom the task is assigned 3520. The user may select a cancel button 3525 to cancel the task. The detail page may also include a tools link list 3530.

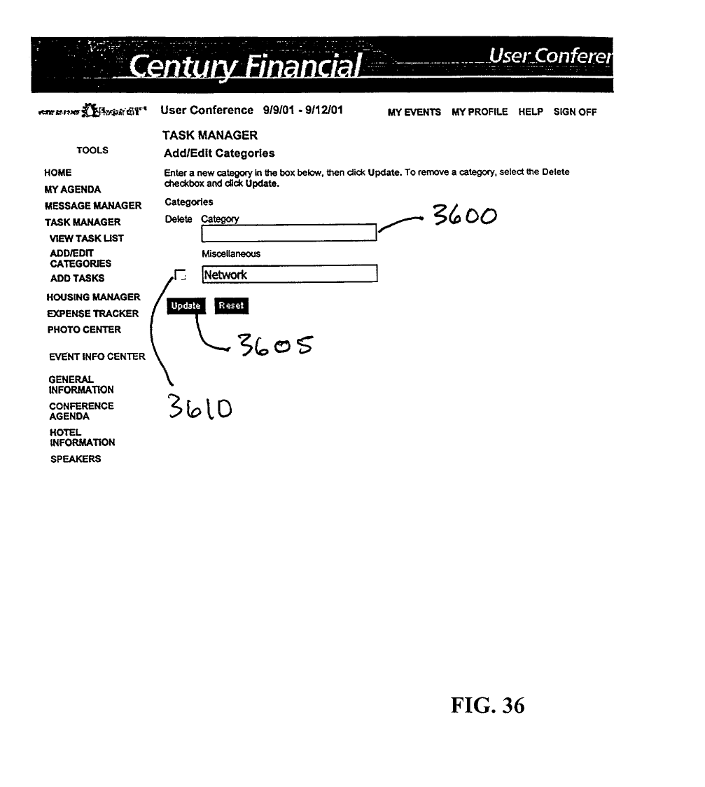

FIG. 36 is an exemplary Web page showing a task manager category creation page in accordance with an embodiment of the present invention. The user may input the name of a new category into the category text entry field 3600 and select the update button 3605 to have the category added to the task list. The user may also select delete check boxes 3610 to delete the category corresponding to the selected box or boxes. The user must select the update button 3605 to have the category deleted from the task list.

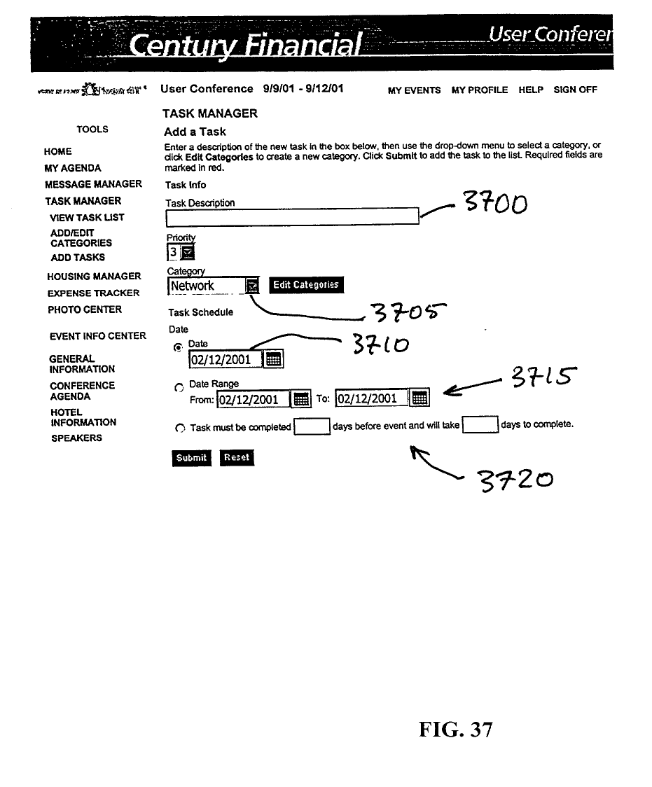

FIG. 37 is an exemplary Web page showing a task manager task creation page in accordance with an embodiment of the present invention. The user may add tasks to the task list at any time. The user may then input a description of the task in the “Task Description” field 3700, the category to which the task belongs in the “Category” field 3705, the date the task is due 3710, a possible time period for performance of the task 3715, and other optional date information 3720. The person to whom the task is to be assigned may also be included. The user may then submit the task for addition to the task list or reset and clear all fields if the entered information is no longer desired.

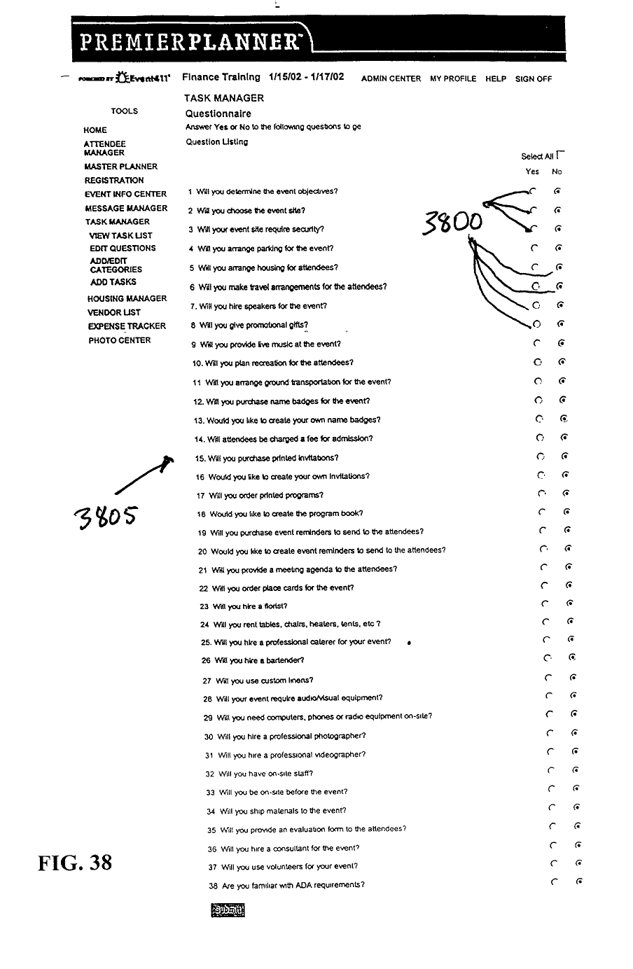

FIG. 38 is an exemplary Web page showing a task generation tool in accordance with an embodiment of the present invention. To utilize the benefits of the task management module, the planner may first develop a list of tasks. The task generation tool can facilitate the development of a task list or a to-do list. The first time the planner accesses the task list tool, the planner may view a set-up screen. There are at least the following options for setting up a task list: (1) task list generation where a list of tasks is created by answering a series of questions; (2) task list personalization where any number of personalized tasks may be created by the user. The user may use a combination of these and other options to develop a task list. Referring to FIG. 38, the user may indicate answers in select boxes 3800 to a series of questions 3805 regarding the event being planned. Based on the answers given, a customized list of tasks may dynamically created including only those tasks that are deemed most applicable to the particular event. The task generation tool may be available to other users in addition to the planner of the event. The task generation tool may be accessible at any time.

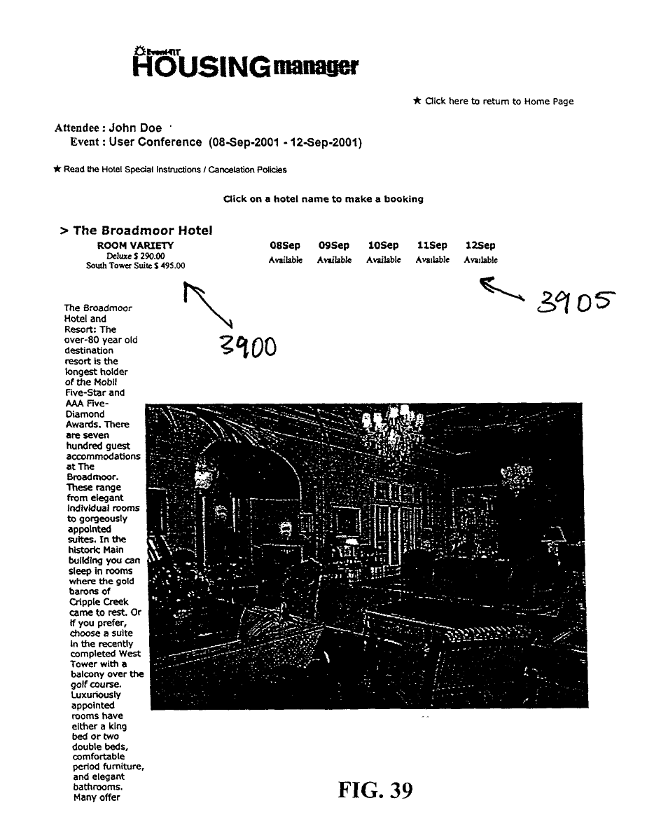

FIG. 39 is an exemplary Web page showing a housing manager page in accordance with an embodiment of the present invention. A housing manager may be included to assist users in setting up hotel and travel accommodations. The housing manager page may include a list of hotels or accommodations available to the user 3900 and dates that the accommodations are available 3905.

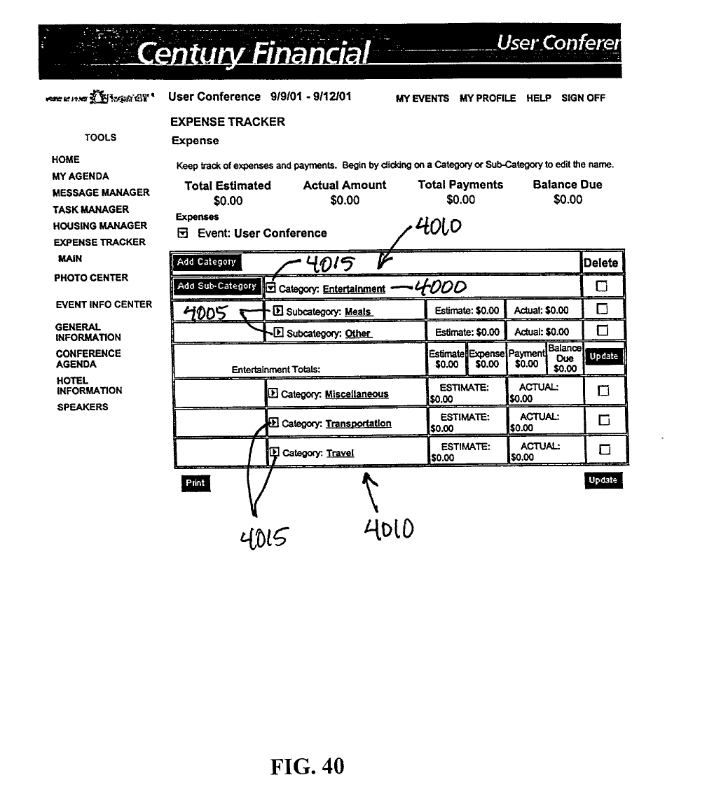

FIG. 40 is an exemplary Web page showing an expense tracker main page in accordance with an embodiment of the present invention. The user can manage and monitor expenses using an expense tracking module that is accessed using the expense tracker Web pages. The expense tracker pages are associated with the expense tracking module on the event management system server. The expense tracking module may retrieve data from the database to perform operations associated with the event info center. The expense tracking module dynamically calculates the expense totals, payments received, and balance due for each category 4000 and sub-category 4005. The expense tracking module utilizes collapsible and expandable menus 4010 to display the desired amount of detail. The menu can be entirely collapsed so that only the name of the event appears. Alternatively, the user may expand the menu to display any combination of categories and sub-categories. Sub-categories can be expanded to show expense items under that particular sub-category. Expanding the menu is preferably done by actuating an icon 4015 indicating whether the menu is expanded or collapsed. The user may also create new categories, sub-categories, and expense items.

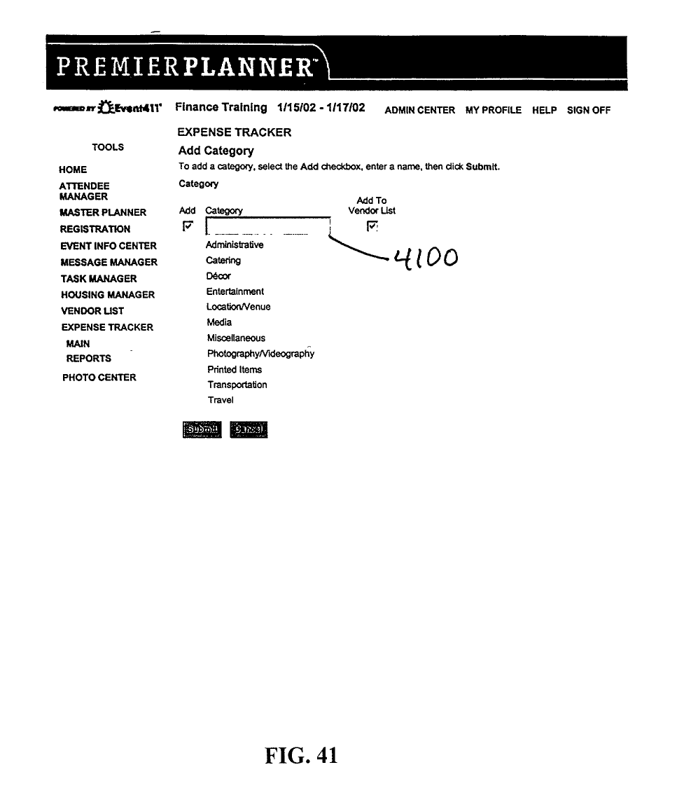

FIG. 41 is an exemplary Web page showing an expense tracker category creation page in accordance with an embodiment of the present invention. Using an add category page the user may input a name for a new category in the category field 4100 and choose whether to add this category to the expense list. The user may add sub-categories in a similar manner. Selection of a submit button will add the entered sub-category to the selected category.

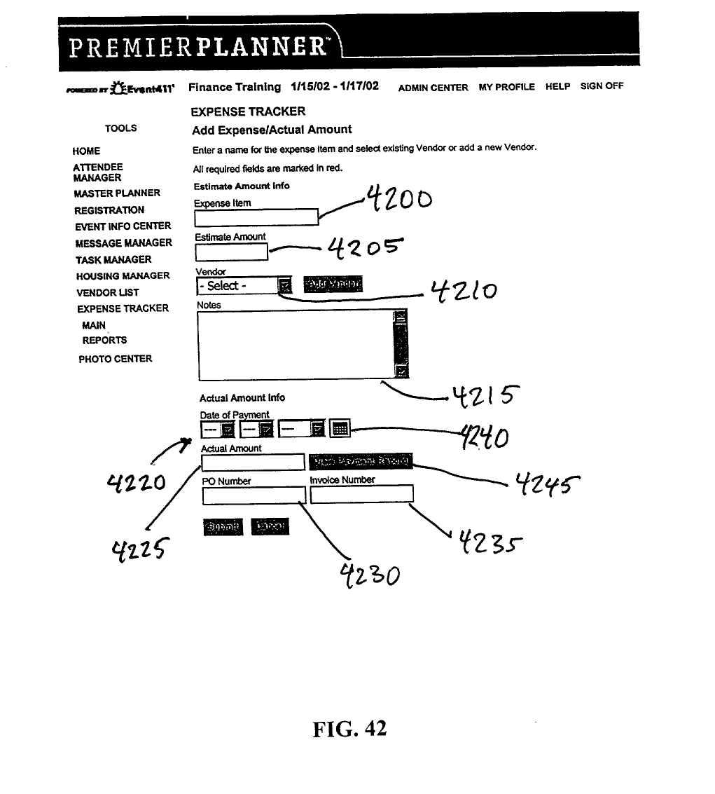

FIG. 42 is an exemplary Web page showing an expense tracker expense entry page in accordance with an embodiment of the present invention. The user can enter estimated expenses as well as the actual expense after the expense is incurred. The user may enter information about the estimate of the amount by entering the name of the item 4200, the estimated amount of the expense 4205, select the vendor from a vendor pull-down menu 4210, and input any additional notes in the notes text entry box 4215 if desired. When the expense is paid the user may enter actual amount info by selecting the date of payment from date pull down menus 4220, the actual amount paid 4225, the purchase order number 4230, and the invoice number 4235. The user may also select to view a calender or view the payment record for a particular expense item by selecting the calender 4240 and view payment record 4245 buttons respectively.

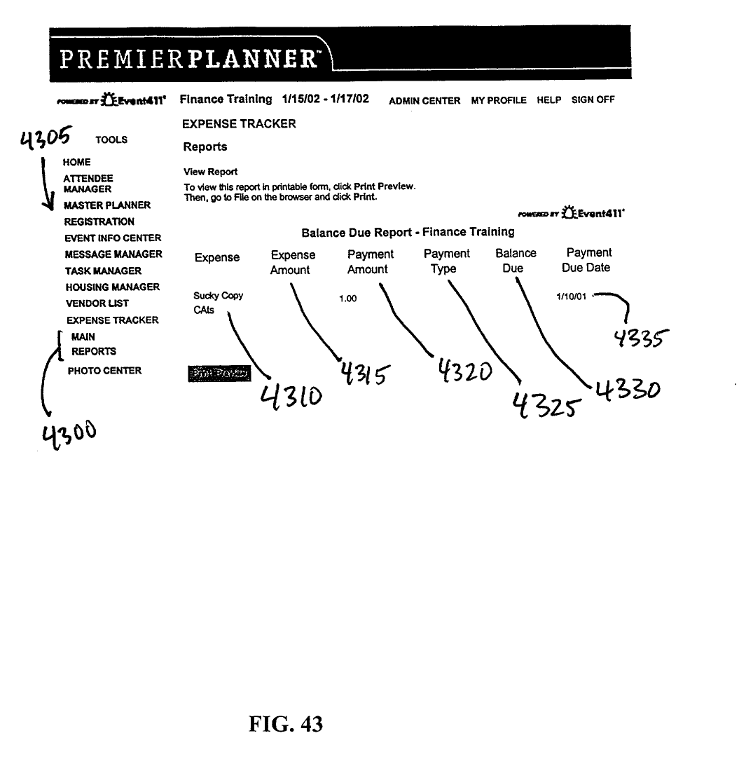

FIG. 43 is an exemplary Web page showing an expense tracker report creation page in accordance with an embodiment of the present invention. A sub-menu 4300 in the tool menu 4305 may allow the user to access the main expense tracking page and access the reports page. The user may use the reports page to generate reports including but not limited to a standard report or a printable report. The user may select between a report of the balance due or the total cost. On the page shown in FIG. 43, the report includes the name of the expense 4310, the expense amount 4315, the payment amount 4320, the payment type 4325, the balance due 4330, and the payment due date 4335. Alternatively, the user may create and view custom reports by following a sequence of pages that allow the user to choose format options. The user may choose to allow others to view reports. The user may format the page and make data selections by choosing data fields from the drop-down menus. The user may preview the report. The user may select groups to appear on the custom report, select the data range, choose the sorting criteria, select any reports that the user wants excluded, and view the report preview. The user may also manage graphics for the expense reports by accessing a page that allows the addition and deletion of graphics. From this page the user may add, delete, or upload graphics. At any time the user may print or delete categories.

In further detail, the expense tracking module is a web-based automation module that provides an efficient, user-friendly, substantially error free method of monitoring and managing expenses. A conventional expense management program functions similarly to a table or spreadsheet. A spreadsheet uses columns and rows typically with categories across the horizontal access and amounts across the vertical access. A user of a spreadsheet would have to create and manage formulas that perform calculations in order to maintain totals and balances. If a user wanted to add a sub-category the user would have to insert a row in-between categories and enter a sub-category title. The user would then have to insert any new expenses and modify the formulas to apply to the new sub-category entries. Any modification to an expense table or spreadsheet would create the need for additional modifications to the format of the spreadsheet and would require changes to the calculation formulas. The modification process is labor intensive and prone to errors. Sub-category totals are difficult to compute. Spreadsheet type programs are not easily integrated into other applications but typically must stand alone.

The expense tracking module automates the creation of new categories, sub-categories, expense items and the modification of all entries associated with the management of expenses. The user may create or edit categories, sub-categories, and expense entries by actuating the appropriate radio button, inputting data into text fields, and selecting data options from drop-down menus. The expense tracking table may be updated and will automatically calculate the estimated expenses, the actual expenses, the payments, and the balances due.

Each user, event, category, and sub-category, and expense item may have an identification number or code. All modules performing operations on expense items can use these codes to keep track of which expense items are associated with each user, event, category, or sub-category. Totals and balances may be made with respect to a particular category and sub-category by summing all of the values of expenses that contain the same category or sub-category code. Similar organization and calculations can be made by using these codes.

The expense tracking module may use hierarchical axes to display different levels of detail. Expenses may be located at either category levels or sub-category levels. The user view only the highest level viewing only the main even or may track expenses at any desired level of detail. An additional row can be added for ever category, sub-category, or expense that the user chooses to view. Therefore, formatting an viewing may be created with flexibility, the user can control the desired format and have more control over their expenditures.

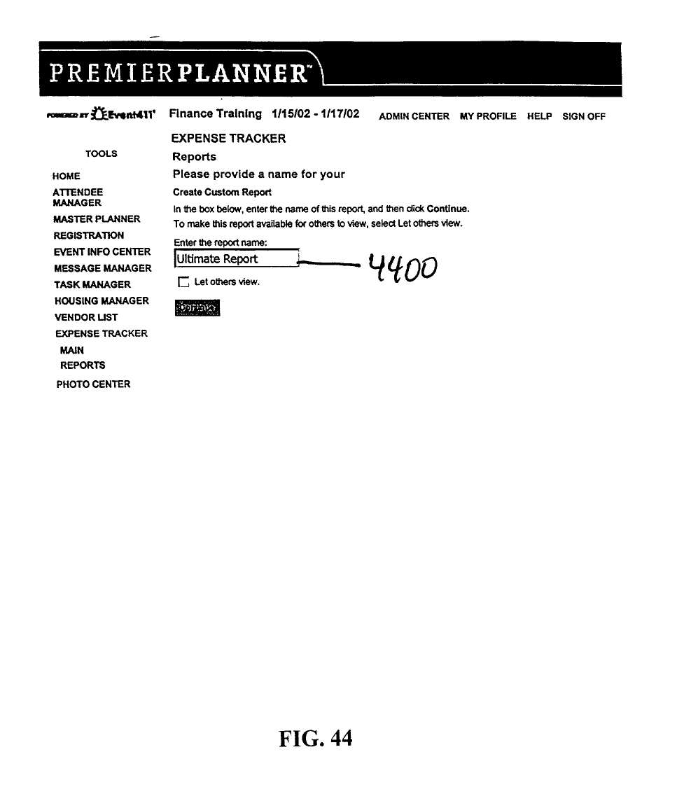

FIG. 44 is an exemplary Web page showing an expense tracker custom report creation page in accordance with an embodiment of the present invention. The user may create a name for the custom report by entering a name in the report name field 4400.

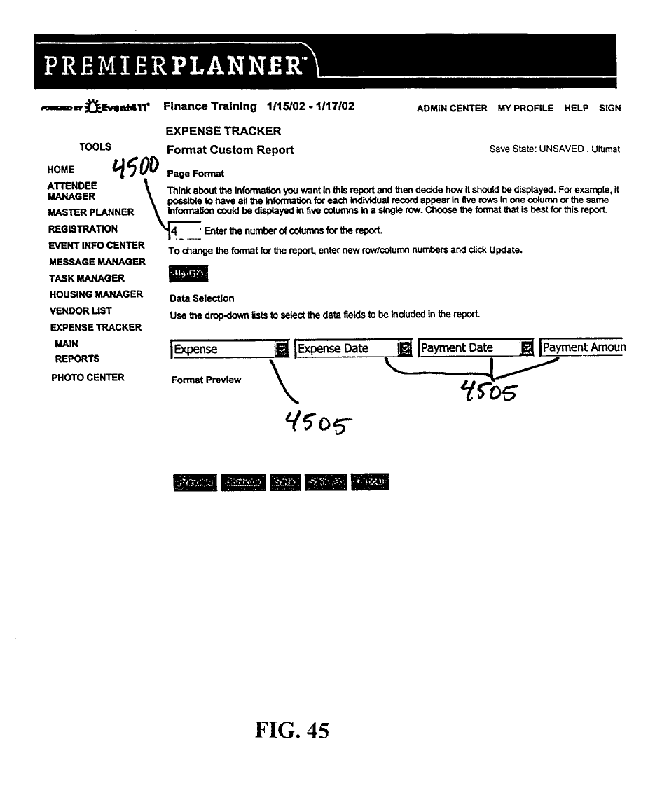

FIG. 45 is an exemplary Web page showing an expense tracker report page format selection page in accordance with an embodiment of the present invention. The user may enter the number of columns for the report in the column number field 4500. The user may select fields from the field selection pull-down menus 4505 to choose the fields to appear on the custom report.

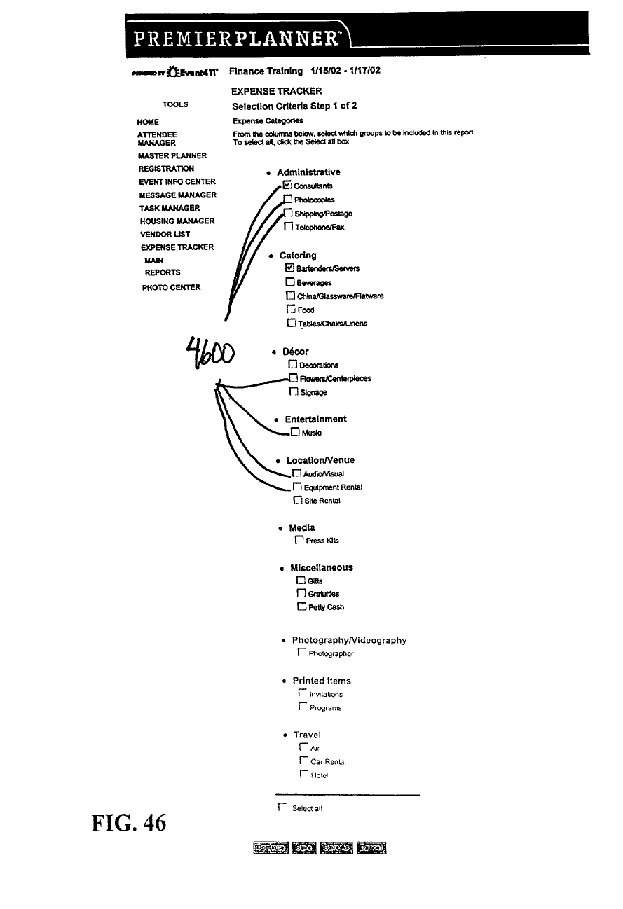

FIG. 46 is an exemplary Web page showing an expense tracker category selection page in accordance with an embodiment of the present invention. The user may select which categories and sub-categories to include in the report by selecting check boxes 4600 from the list of categories and sub-categories. On additional report creation pages, the user may be able to choose a date range for the report, a method for sorting expenses in the report, sorting by multiple criteria in a determined order, identify records to be excluded from the report, preview the report before printing, and import graphics to add to the report.

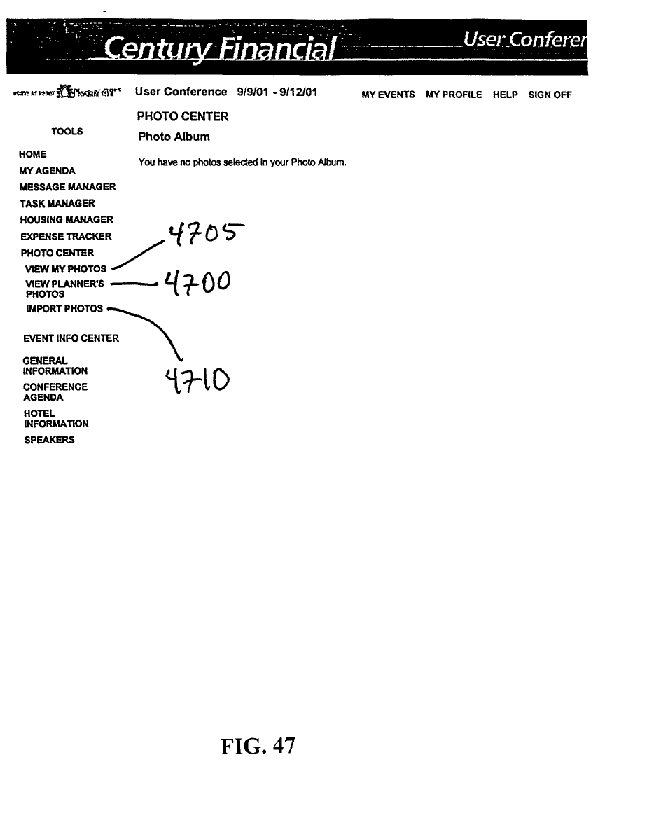

FIG. 47 is an exemplary Web page showing a photo center photo album page in accordance with an embodiment of the present invention. A photo center system allows the user to maintain a personalized collection of photos. The user may also use the photo center to view photos that have been made available by the planner of the event by selecting the view planner's photos link 4700. The user may select photos from the planner's collection of photos for display in the user's owner photo album 4705. Alternatively, the user may import photos from files maintained outside of the event management module by selecting the import photos link 4710.

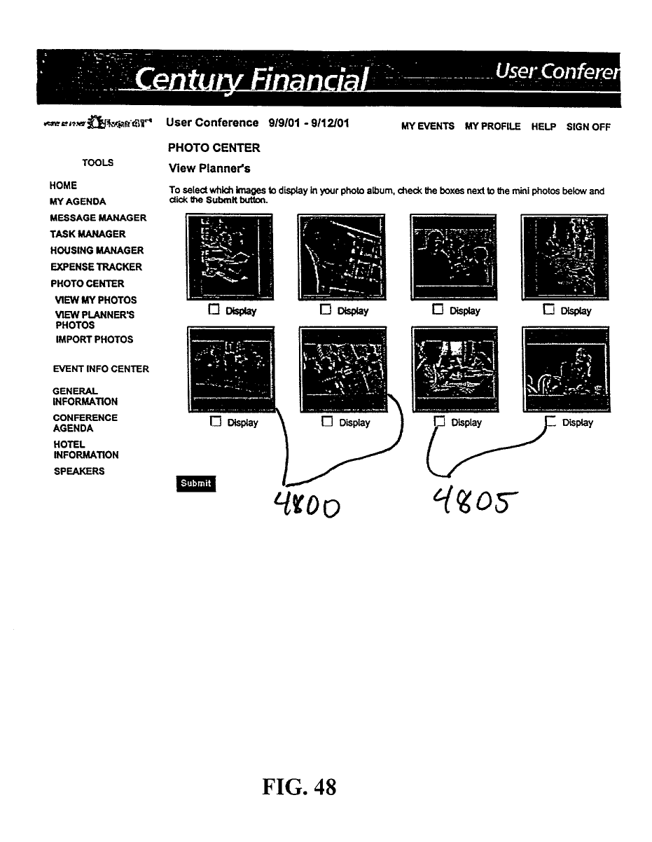

FIG. 48 is an exemplary Web page showing a photo center planner's photos page in accordance with an embodiment of the present invention. The event planner's photos 4800 are displayed on the page. The user may select display check boxes 4805 to choose photos to be displayed in the user's photo album.

Tools menus and hyperlink buttons may appear along the side of the screen, the top of the screen, or at any desired location on pages within the event planning management module. Tools link list menus provide quick access to pages within the event planning management module including but not limited to sub-tool items, other tools, home pages, personal profiles, and help pages.

In addition, an exemplary embodiment of the present invention has been presented for use with HTML documents. Those skilled in the art will recognize that any electronic document composed in any markup language may be implemented for use in event management system. These electronic documents may be displayed on a variety of devices including handheld general purpose computers, personal digital assistants (PDAs), and wireless telephones with access to a digital communications network such as the Internet.

Although this invention has been described in certain specific embodiments, those skilled in the are will have no difficulty devising variations which in no way depart from the scope and spirit of the present invention. It is therefore understood that this invention may be practiced otherwise than is specifically described. Thus, the present embodiments of the invention should be considered in all respects as illustrative and not restrictive. Other means for submitting and inputting information, including text fields, radio buttons, pull-down menus, icon selection, and text hyperlinks, will be known to those skilled in the art. Other visual representations of the present invention will be immediately apparent to those skilled in the art. Accordingly, the present invention is not limited to the specific embodiments described above, but rather, is defined by the scope of the appended claims.

What is claimed is:

1. A computerized method for managing event information using a data communications network comprising:
providing an event management server operably coupled to the data communications network;
providing a database operably coupled to the event management server having event specific information stored thereon;
receiving by the event management server from a planner client a modification of the event specific information via the data communications network;
dynamically updating by the event management server the event specific information stored on the database using the modification of the event specific information;
receiving by the event management server from a user client an event information request via the data communications network;
generating by the event management server the dynamically updated event specific information; and
transmitting by the event management server to the user client the dynamically updated event specific information via the data communications network.

2. The method of claim 1, wherein generating the dynamically updated event specific information includes generating event data using an event information center module, the event data including at least one of event detail information, event schedule information, hotel information, and speaker information.

3. The method of claim 1, wherein generating the dynamically updated event specific information includes generating task data using an a task management module, the task data including at least one of user name, task description, task category, and task date.

4. The method of claim 1, wherein generating the dynamically updated event specific information includes generating expense data using an expense tracking module, the event data including at least one of expense category, expense subcategory, expense estimate, actual expense, and balance due.

5. A computerized method for managing event information using a data communications network comprising:
providing an event management server operably coupled to the data communications network;
providing a database operably coupled to the event management server having event specific information stored thereon;
generating an event site displaying the event specific information;
receiving a modification request from a user client requesting modification to the event specific information, the modification request using a data processing module;
dynamically updating the event specific information;
generating the dynamically updated event specific information; and
transmitting the dynamically updated event specific information to the event site, wherein the dynamically updated event specific information is displayed.

6. The method of claim 5, wherein the data processing module is an event information center module, the event specific information including at least one of event detail information, event schedule information, hotel information, and speaker information.

7. The method of claim 5, wherein the data processing module is a task management module, the event specific information including at least one of user name, description, category, and date.

8. The method of claim 5, wherein the data processing module is an expense tracking module, the event specific information including at least one of expense category, expense subcategory, expense estimate, actual expense, and balance due.

9. The method of claim 5, wherein event specific information includes user-specific information associated with each of a plurality of users, and transmitting the dynamically updated event specific information to the event site includes the steps of:
receiving a user identification from one of the plurality of users; and
transmitting a user-specific event page to the one of the plurality of users, the user-specific event page including the event specific information and the user-specific information.

10. The method of claim 5, wherein the user client is one of a planner client, an administrator client, and an attendee client.

11. A computerized method for managing event information using a data communications network comprising:
transmitting a user identification to an event management server operably coupled to the data communications network;
receiving a user-specific web page display, the web page display including event data, the event data stored on an event management database coupled to the event management server; and
transmitting a request to the event management server over the data communications network, transmitting the request using a data processing module, the data processing module configured to modify event data in response to the request.

12. The method of claim 11, wherein the data processing module is a task management module, the request to the event management server including a task generation request and a task assignment request.

13. The method of claim 11, wherein the data processing module is a task management module, the request to the event management server including a task modification request.

14. The method of claim 11, wherein the data processing module is an expense tracking module, the request to the event management server including an expense modification request, the expense modification request including on of the steps of creating an expense category, creating an expense subcategory, adding an expense estimate, adding an actual expense amount, and deleting expense entries.

15. A computerized event planning system comprising:
an event management server operably coupled to a data communications network;
an event management database operably coupled to the event management server, the event management database having event data;
a data processing module operably coupled to the event management server, characterized in that the data processing module receives a user request transmitted over the data communications network from a system user, further characterized in that the data processing module modifies the event data in response to the user request, and transmits the modified event data to the system user over the data communications network.

16. The system of claim 15, wherein the data processing module is an event information center module, wherein the event information center module is configured to process event information data.

17. The system of claim 15, wherein data processing module is a task management module, wherein task management module is configured to process task data, the task management module further configured to generate a task and assign the task to a second system user.

18. The system of claim 15, wherein data processing module is an expense tracking module, wherein the expense tracking module is configured to process expense data, the expense tracking module further configured to generate expense records, the expense tracking module further configured to execute an expense calculation.

19. The system of claim 15, wherein the system user is an event planner.

20. The system of claim 15, wherein the system user is an event attendee.

21. The system of claim 15, wherein the system user is an event management system administrator.
